(19) United States
(12) Patent Application Publication
(10) Pub. No.: US 2019/0313586 A1
(43) Pub. Date: Oct. 17, 2019

(54) ATRIUM/HYBRID MULTI-PURPOSE GREENHOUSE BUILDING

(71) Applicant: ANCON DEVELOPMENT CORPORATION, Escondido, CA (US)

(72) Inventor: Terry Van Gelder, Escondido, CA (US)

(73) Assignee: ANCON DEVELOPMENT CORPORATION, Escondido, CA (US)

(21) Appl. No.: 16/363,900

(22) Filed: Mar. 25, 2019

Related U.S. Application Data
(60) Provisional application No. 62/648,319, filed on Mar. 26, 2018.

(51) Int. Cl. A01G 9/14; E04D 3/14; E04B 9/32; E04C 3/09; E04C 2/54; E04D 13/16; A01G 9/24

(52) U.S. Cl. CPC A01G 9/14; E04D 3/14; E04B 9/32; E04C 2003/0452; E04C 2/54; E04D 13/16; A01G 9/24; E04C 3/09

(57) ABSTRACT

The present application is directed to Large Enclosed Secure Greenhouse Structure Atrium/Hybrid Greenhouse Buildings that have the appearance of a new modern industrial building that will provide a complete agricultural growing facility with an office, maintenance and dry storage spaces. The roof and walls of the greenhouse area have a continuous sealed chamber through transparent open web joists and girders, with controlled sunlight transmission along with heat and cold circulation. More particularly, the Atrium/Hybrid Greenhouse Building provided is constructed using a number of joist and girder systems configured to support transparent reinforced roof, wall and ceiling panels, assembled in a way that provides maximum daylight transmission and significant insulating properties, enabling the Atrium/Hybrid Greenhouse Building to be an effective and economical grow-house in harsh environments and in areas with snowfall or widely varying temperature ranges. The air in the building will be filtered through a system capable of filtering out a variety of particle matter including pesticides and herbicides with clean rooms between separate growing areas and exit areas. The Atrium/Hybrid Greenhouse Building provided is constructed using a number of joist and girder systems configured to support transparent reinforced roof, wall and ceiling panels.

### FIELD OF THE INVENTION

This application relates to a unique design of Large Enclosed Secure Greenhouse Structure Atrium/Hybrid Greenhouse Buildings that have the appearance of a new modern industrial/technology building that does not have the conventional fragile plastic tented or the conventional fragile sharp angled glass panel greenhouse look. More particularly, the Atrium/Hybrid Greenhouse Building provided is constructed using a number of joist and girder systems configured to support transparent reinforced roof, wall and ceiling panels, assembled in a way that provides maximum daylight transmission and significant insulating properties, enabling the Atrium/Hybrid Greenhouse Building to be an effective and economical grow-house in harsh environments and in areas with widely varying temperature ranges.

### BACKGROUND OF THE INVENTION

There is a growing need to provide a Large Enclosed Secure Greenhouse Structure for growing expensive delicate plants that are for sale. Most delicate hybrid plants must be grown within controlled temperate climates. Greenhouses usually have a fragile structural design and need a large land area and have an unsightly appearance. Vast housing developments are taking over the desirable rural land in areas close to the cities where conventional greenhouses are not permitted. Conventional greenhouses need to be in a more temperate climate and usually cannot stand any great fluctuations of the day light and temperature. Controlling the ambient lighting and temperature conditions in the greenhouse will be the very best environment for growing a wide variety of delicate hybrid plants.

Numerous innovations for structures have been provided in the prior art described as follows. Even though these innovations may be suitable for the specific individual purposes to which they address, they differ from the present Large Enclosed Secure Greenhouse Structure as hereinafter contrasted. The following is a summary of those prior art patents most relevant to the Large Enclosed Secure Greenhouse Structure at hand, as well as a description outlining the difference between the features of the present application and those of the prior art.

U.S. Pat. No. 5,335,447 of Richard A. Bee describes a thermally efficient integrated greenhouse system in which thermally insulated walls support an arcuate transparent roof having the configuration of an arc of a quarter-circle with the long axis of the structure oriented in an east-west direction with the inner surface of the north wall reflective. A thermal barrier made up of a plurality of interconnected tubes of metalized plastic is provided with means for inflating the tubes to extend the barrier along a chord of the arcuate roof and with means for exhausting the tubes to retract the barrier. Solar panels along the south side of the greenhouse supply heat to a heat storage medium contained in a bin in the greenhouse. When heat is called for, a plenum in the bin above the heat storage medium is pressurized to lift the bin lid.

This patent describes a thermally efficient integrated greenhouse system that does not provide the complete segments of the growing operation where the Large Enclosed Secure Greenhouse Structure offers varying combinations or transparent roof panels, roll formed open web joists and girders on the walls and roof structure that create a transparent sealed cavity where warm and cold air is directed to keep an even temperature, clean rooms to keep a sterile growing environment, along with office space, maintenance and storage rooms.

U.S. Pat. No. 6,131,363 of Robert D. Phillips describes a commercial greenhouse roof and roof glazing system that maximizes the intake of direct winter sunlight while managing spring, summer and fill sunlight to similar levels so that continuous produce and other crops can be grown. This system has transparent corrugated roofing sheets with north and south facing sections running in an east/west direction, where portions of the outer face of the outer glazing sheet are coated, insulation separates each sheet at locations of top surface coating, gas spaces separate each sheet at locations of no coating, and reflective material coats the interior surface of the interior sheet at portions of insulation. This system has no moving parts other than the movement of the sun in relationship to the structure. The color of the sunlight spectrum is split in the summer months so that the photosynthetic active portion is maximized in summer months leaving the unwanted summer heat gain outside of the structure. Since all of the light is taken in through the root the walls can be of conventional architectural materials which allows the total growing facility to be placed at grade level or on the top floor of urban area buildings. This eliminates the need for much of the packing and fossil fuel-run distribution systems that typical growing facilities endure.

This patent describes a commercial greenhouse roof and roof glazing system that maximizes the intake of direct winter sunlight while managing swing, summer and fill sunlight to similar levels where the Large Enclosed Secure Greenhouse Structure provides complete segments of the growing operation. With its sleek modern design, it can be constructed at any angle and in many areas where conventional greenhouses are not permitted

U.S. Pat. No. 6,898,902 of Johnnes Andres Stoffers et al. describes a Greenhouse provided with a roof element having a multiplicity of transverse ribs or pyramids uniformly distributed over the roof element. The roof element can be constructed double-walled as a. hollow-core sheet from transparent plastic and can comprise a base sheet with the rib-shaped or pyramid-shaped roof surfaces fixed thereon. The light yield in a horticultural greenhouse can be increased by the roof elements.

This patent describes a Greenhouse provided with a roof element having a multiplicity of transverse ribs or pyramids with a single panel design but does not incorporate the unique roll formed open web joists and girders on the wall and roof structure to create a transparent sealed cavity where warm and cold air is directed to keep an even temperature when the Large Enclosed Secure Greenhouse Structure is constructed at any location.

U.S. Pat. No. 7,546,708 of Moshe Konstantin describes a glazing panel system that is provided using retention clips formed of folded sheet metal having a top flange for engaging and retaining a pair of glazing panel ends against uplift forces generated by high velocity winds flowing across the glazing panels. The preferred one-piece retention clip has a two-ply central web which is formed on the retention clip to be positioned at a seam between adjacent glazing panels and these plies may be welded together to increase the strength of the central web. This top flange is strengthened to resist bending of its right or left flange section by raised portions extending normal to the fold lines that join the respective top flange sections to the top of the central web. The preferred retention clip also is formed with spot welds to join the two plies of the central web.

This patent describes a glazing panel system but does not deal with any of the variety of unique operational features described in the Large Enclosed Secure Greenhouse Structure along with the use of the unique roll formed open web joists and girders on the wall and roof structure to create a transparent sealed cavity where warm and cold air is directed to keep an even temperature.

U.S. Pat. No. 8,839,551 of James J. Swann describes an apparatus and system that are disclosed for a self-regulating greenhouse. The apparatus includes a horizontal air pathway disposed within a growing bed, and a vertical air pathway extending upward from the horizontal air pathway through the growing bed to an air intake apparatus positioned adjacent the roof. The system includes the apparatus and a structure comprising walls and a roof formed of at least a first transparent sheet coupled with a rotatable arm and an adjacent second transparent sheet coupled with an extending arm such that when the extending arm lifts the second transparent sheet an opening is formed in the roof between the first and second transparent sheets to allow a flow of air between an interior of the structure and an exterior of the structure. The system also includes an external surface of a formed transparent membrane allowing sunlight to enter the structure.

This patent describes an apparatus and system disclosed for a self-regulating greenhouse, but it does not describe a complete greenhouse sensitive plant growing operation.

US Patent Publication No. 2005/0011145 of Yaron Mayer et al. describes a corrugated transparent or semi-transparent structure, typically from Polycarbonate or Acrylic, that are typically used for creating for example various transparent or semi-transparent walls or roofs for example in large buildings or for creating greenhouses for plants. However, especially for example during the summer, this can cause overheating of the greenhouse effect, so that too much heat is caught inside, which can have undesirable effects. The present invention shows a very cheap solution for automatically regulating the penetration of the Sun's rays through such structures during the day, so that for example at noon the Sun's penetration is automatically lowered. This is preferably achieved by using a sandwich in which two external transparent plates are connected by non-transparent or at least less transparent inner walls (also called bridges) and using appropriate orientations so that when the Sun rises or sets, the Sun's rays can easily enter more directly and when the Sun rises at noon the non-transparent or less transparent inner bridges block direct light from the Sun.

This patent describes a Corrugated transparent or semi-transparent structure, but it does not describe a complete greenhouse sensitive plant growing operation.

US Patent Publication No. 2016/0219796 of Emilio Rodriguez Cabeo describes an in-plant cultivation, it is common in many cases to grow certain crops under film covers, in greenhouses or under other roofing. Depending on the climate zone and crop, this can be used for example to supply heat by retaining the sunlight or by means of additional heating. The invention relates to a plant cultivation roofing made of film material or plate material having temperature-dependent radiation transparency, wherein a plastic layer in or on a plate or at least one film layer having temperature-dependent radiation transparency provides a gradual or a two-step or multi-step transparency reduction for rising temperatures in a temperature range from 20 degrees.

This patent describes a plant cultivation roofing made of film material or plate material having temperature-dependent radiation transparency and does not describe a complete greenhouse sensitive plant growing operation.

US Patent Publication No. 2009/0223148 of Richard McClure describes a light-transmitting roof panel assembly, having the same shape as adjoining metal roof panels in a standing seam metal roof, includes an outer transparent panel made of a polymeric material and an inner reinforcing panel made of perforated metal. The inner and outer panels nest together and lie flush with the roof. Crimpable side corrugation pieces are attached to the reinforcing panel so that the assembly can be connected to neighboring roof panels by seaming.

This patent describes a light-transmitting roof panel assembly, having the same shape as adjoining metal roof panels and does not describe a complete greenhouse sensitive plant growing operation.

None of the foregoing prior art teaches or suggests the particular unique features of the Large Enclosed Secure Greenhouse Structure and thus clarifies the need for further improvements in the structures that can be used for these purposes.

In this respect, before explaining at least one embodiment of the Large Enclosed Secure Greenhouse Structure detail it is to be understood that the design is not limited in its application to the details of construction and to the arrangement of the components set forth in the following description or illustrated in the drawings. The Large Enclosed Secure Greenhouse Structure is capable of other embodiments and of being practiced and carried out in various ways. Also, it is to be understood that the phraseology and terminology employed herein are for the purpose of description and should not be regarded as limiting.

### SUMMARY OF THE INVENTION

The preferred embodiment of the Large Enclosed Secure Greenhouse Structure is created to provide a structure that will have an absolutely controlled environment no matter where it is located.

An advantage of the Large Enclosed Secure Greenhouse Structure is to create a structure that is lockable and not vulnerable to be broken into easily.

Another advantage of the Large Enclosed Secure Greenhouse Structure is that it will have transparent open web columns, girders and open web joists for maximum daylight.

Another advantage of the Large Enclosed Secure Greenhouse Structure is that it will have automatically controlled ambient lighting conditions.

Another advantage of the Large Enclosed Secure Greenhouse Structure is that it will provide a complete agricultural growing facility.

Another advantage of the Large Enclosed Secure Greenhouse Structure is that it will house an office space, one or more decontamination rooms, secured hallways, storage space, transportation truck loading docks and a maintenance facility along with the greenhouse area.

Another advantage of the Large Enclosed Secure Greenhouse Structure is that it will have four or more isolated decontamination areas, and secured hallways.

Another advantage of the Large Enclosed Secure Greenhouse Structure is that it will have an intake fan oil bath filtration system capable of filtrating out a variety of particle matter including pesticides, herbicides, airborne pollens, fungi and fungi spores or any other contaminant which would affect the interior confined crop growth in the grow room area.

Another advantage of the Large Enclosed Secure Greenhouse Structure it that the walls and ceiling structures will incorporate open web joists and girders creating a uniquely designed sealed air chamber.

Another advantage of the Large Enclosed Secure Greenhouse Structure is having a sealed air chamber in the walls and ceiling is that it receives an exchange of filtered heated or cold air.

Another advantage of the Large Enclosed Secure Greenhouse Structure is the ability of having a different roof configuration from slightly pitched to a variety of domed shapes.

Another advantage of the Large Enclosed Secure Greenhouse Structure is that it will have a fully automated irrigation system.

Another advantage of the Large Enclosed Secure Greenhouse Structure is it is a uniquely designed greenhouse structure,

Another advantage of the Large Enclosed Secure Greenhouse Structure is the unique defined structural girders.

Another advantage of the Large Enclosed Secure Greenhouse Structure is the unique defined structural open web joists.

These together with other advantages of the Large Enclosed Secure Greenhouse Structure, along with the various features of novelty, which characterize the design are pointed out with particularity in the claims annexed to and forming a part of this disclosure. For a better understanding of the Large Enclosed Secure Greenhouse Structure its operating advantages and the specific objects attained by its uses, reference should be made to the accompanying drawings and descriptive matter in which there are illustrated the preferred and alternate embodiments of the Large Enclosed Secure Greenhouse Structure. There has thus been outlined, rather broadly, the more important features of the design in order that the detailed description thereof that follows may be better understood, and in order that the present contribution to the art may be better appreciated. There are additional features of the Large Enclosed Secure Greenhouse Structure that will be described hereinafter, and which will form the subject matter of the claims appended hereto.

The preferred embodiment of the Large Enclosed. Secure Greenhouse Structure will have a low-pitched roof with an office section with office space, storage space and maintenance facility, or a high-pitched roof for use in areas/regions that receive snowfall. High-pitched roofs can be used in order to keep the roof clear of snow, so that natural daylighting can still be used in areas receiving heavy snowfall amounts.

The alternate embodiment of the Large Enclosed Secure Greenhouse Structure will have a domed (or barrel shaped) roof structure with office space, decontamination rooms, storage space, a maintenance facility, secured hallways and an optional truck loading dock area.

Atrium/Hybrid Greenhouse Building features will include:
1. Open web columns, girders and open web joists for maximum daylighting Solid web members may be used for less day lighting.
2. All framing members to be galvanized and sprayed with a reflective coating.
3. Sealed air chambers between roof and ceiling panels.
4. Sealed air chambers between interior and exterior wall panels.
5. At sealing air chambers (wall or roof) use proprietary electrically, vaporized/atomized/thermal enhanced liquids/fog gases or smoke agents for insulation value, sunlight blocking and sunlight enhancement. Sealed air chambers may also received air exchange of heated or cold air. Sealed air chambers can intake or ventilate natural air through filters using mechanical devices.
6. All roof, wall and ceiling panels shall be transparent and may be manufactured from any transparent product. All transparent roof panels shall incorporate perforated metal, fiber or wire mesh lamination or underlayment to protect from accidental fall through of the transparent roof panels. Transparent roof panels to withstand all external roof loads prescribed by local municipal, state or federal building codes. The use of electrocromatic glass (smart glass) or electrically controled wall, roof or ceiling panels will be used. Glass can be electrically changed from clear to completely blackout including changing the insulation value electronically. The sealed air chamber is the concealed area between the roof and ceiling transparent panel an also at the exterior and interior transparent wall panels.
7. The use of cloth draping or mechanical louver systems can be used at the transparent wall, roof or ceiling panels for control of sunlight including complete blackout.
8. Entire concrete floor to be sealed and sprayed with a reflective coating to reflect upwards under plants.
9. Use of horizantal reflective panels positioned under plants to reflect light up under plants, as well as growlights installed under plants and plant growing structures.
10. All interior divider walls to have reflective coating also to include ceiling panels. Internal partition walls can be insulated or non-insulated panels with reflective coating or can be fire rated insulated or non-insulated panels with reflective coating. The use of fire rated plant growing divider panels aids in eliminating the use of fire suppression sprinkler systems in the growing and other associated rooms.
11. Rounded or radius eve lines.
12. Internal rain gutters before cave line and internal rain gutters having a rounded perforated metal cap for snow movement over the internal rain gutter without snagging on or damaging the rain gutter.
13. Specialized contraction and expansion structural movement plate or hat channel for attachment to transparent roof or ceiling movement plate can be attached to bottom or top of open web joist.
14. Specialized hangers at ceiling for support of lights, fire sprinklers, mechanical and other ceiling hung fixtures.

With respect to the above description then, it is to be realized that the optimum dimensional relationships for the parts of the Large Enclosed Secure Greenhouse Structures, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present design. Therefore, the foregoing is considered as illustrative only of the principles of the Large Enclosed Secure Greenhouse Structure. Further, since numerous modifications and changes will readily occur to those skilled in the art, it is not desired to limit the Large Enclosed Secure Greenhouse Structure to the exact construction and operation shown and described, and accordingly, all suitable modifications and equivalents may be resorted to falling within the scope of this application.

### BRIEF DESCRIPTION OF THE DRAWINGS

The accompanying drawings, which are incorporated in and form a part of this specification, illustrate embodiments of the Large Enclosed. Secure Greenhouse Structures and together with the description, serve to explain the principles of this application.

FIG. 1A depicts a perspective view of a front to side elevation of the low-pitched (or flat) roof of the Large Enclosed Secure Greenhouse Structure.

FIG. 1B depicts a perspective view of the rear to side elevation of the low-pitched (or flat) roof of the Large Enclosed Secure Greenhouse Structure.

FIG. 2A depicts a perspective view of a front to side elevation of the domed (or barrel) high-pitched roof of the Large Enclosed Secure Greenhouse Structure.

FIG. 2B depicts a perspective view of the rear to side elevation of the domed (or barrel) high-pitched roof of the Large Enclosed Secure Greenhouse Structure.

FIG. 3 depicts a perspective schematic of the interior components of the Large Enclosed Secure Greenhouse Structure.

FIG. 4A depicts a perspective of a rear portion of the Large Enclosed Secure Greenhouse Structure illustrating the installation of the roof panels, FIG. 4B depicts a partially broken away view of a single roof panel, and FIG. 4C depicts detail of a portion of a roof panel.

FIG. 5A depicts an edge view of the single skin transparent panel reinforcement with transparent fiberglass polycarbonate or equal panels shown mounted on a joist using a z clip.

FIG. 5B depicts a perspective view of the single skin transparent panel reinforcement with transparent fiberglass polycarbonate or equal panels.

FIG. 6 depicts a cross section through the Large Enclosed Secure Greenhouse Structure.

FIG. 7 depicts a cross section of one half of the Large Enclosed Secure Greenhouse Structure illustrating the side wall and interior walls along with the roof rafter design.

FIG. 8A depicts a side view of the greenhouse curved edge of the roof and upper side wall construction.

FIG. 8B depicts a plan view of a section of the greenhouse curved junction of the roof and upper side wall construction.

FIG. 9 depicts a side view of the greenhouse transparent upper side wall construction.

FIG. 10 depicts a side view of the greenhouse solid lower side wall construction.

FIG. 11A depicts a side view of a portion of the segmented girder with a segmented open web joist in position.

FIG. 11B depicts a segmented open web joist in the conventional vertical position.

FIG. 11C depicts a segmented open web joist in a horizontal position to be used as a structural reinforcement member in wall construction.

FIG. 12 depicts side view of a portion of the segmented girder with the utility ceiling spacer, mounting bracket and segmented open web joist bracket incorporating the roof and ceiling spacer brackets.

FIG. 13 depicts a side view of a conventional steel girder.

FIG. 14 depicts a side view of two segmented open web joists spanning between room dividing walls.

FIG. 15 depicts a side view of a typical segmented open web joist.

FIG. 16 depicts a side view of two open web bar joists spanning h room dividing walls.

FIG. 17 depicts a side view of two open web bar joists, as well as the installation of a specialized transparent light fixture in the ceiling.

FIG. 18 depicts a side view of the preferred embodiment of the roll formed galvanized steel channel segmented open web joist.

FIG. 19 depicts a cross section through a roll formed galvanized steel segmented (unistrut type) open web joist member.

FIG. 20 depicts a cross section through a roll formed galvanized steel segmented (unistrut type) open web joist member with optional elevated roll formed horizontal channel.

FIG. 21A, 21B and 21C depicts perspective views of the three different configurations of the preferred joist embodiments, wherein FIG. 21A illustrates a roll formed galvanized steel segmented (unistrut type) open web joist horizontal member, FIG. 21B illustrates a roll formed galvanized steel segmented (unistrut type) open web joist member with optional top or bottom roll formed channels, and FIG. 21C illustrates a roll formed galvanized steel segmented (unistrut type) open web joist member with elevated roll formed channel at the top or bottom.

FIG. 22 depicts a side view of the first alternate embodiment of the roll formed galvanized steel segmented (unistrut type) open web joist.

FIG. 23 depicts a cross section through a roll formed galvanized steel segmented (unistrut type) open web joist member,

FIG. 24 depicts a cross section through a roll formed galvanized steel segmented (unistrut type) open web joist member with optional elevated horizontal channel.

FIG. 25A, 25B and 25C depicts perspective views of the three different configurations of the first alternate joist embodiments, wherein FIG. 25A illustrates a roll formed galvanized steel segmented (unistrut type) open web joist horizontal member, FIG. 25B illustrates a basic steel galvanized roll formed channel (unistrut type) segmented open web joist with optional top channel and FIG. 25C illustrates a basic galvanized steel roll formed channel (unistrut type) horizontal segmented open web joist with elevated roll formed channel at the top or bottom.

FIG. 26 depicts a side view of the second alternate embodiment of the roll formed galvanized steel segmented (unistrut type) open web joist.

FIG. 27 depicts a cross section through a roll formed galvanized steel segmented (unistrut type) open web joist member.

FIG. 28 depicts a cross section through a roll formed galvanized steel segmented (unistrut type) open web joist member with optional elevated roll formed horizontal channel.

FIG. 29A, 29B and 29C depicts perspective views of the three different configurations of the second alternate segmented open web joist embodiments, wherein FIG. 29A illustrates a roll formed galvanized steel segmented (unistrut type) open web joist having a bolted or welded construction, FIG. 29B illustrates a roll formed galvanized steel segmented (unistrut type) open web joist horizontal member with optional top or bottom roll formed channel, and FIG. 29C illustrates a roll formed galvanized steel segmented (unistrut type) open web joist member with optional elevated roll formed galvanized channel at the top or bottom.

FIG. 30 depicts a side view of the third alternate embodiment of the roll formed galvanized steel segmented (unistrut type) open web joist.

FIG. 31 depicts a cross section through a roll formed galvanized steel segmented (unistrut type) open web joist.

FIG. 32 depicts a cross section through a roll formed galvanized steel segmented (unistrut type) open web joist member with optional elevated roll formed horizontal channel.

FIG. 33A, 33B and 33C depicts perspective views of the three different configurations of the third alternate roll formed galvanized steel (unistrut type) segmented open web joist embodiments, wherein FIG. 33A illustrates a roll formed galvanized steel segmented (unistrut type) open web joist with bolted or welded construction, and FIG. 33B illustrates a roll formed galvanized steel segmented (unistrut type) open web joist horizontal member with optional top or bottom roll formed channel, and FIG. 33C illustrates a roll formed galvanized steel segmented (unistrut type) open web joist member with optional elevated roll formed channel at the top or bottom.

FIG. 34 depicts a side view of the forth alternate embodiment of the roll formed galvanized steel segmented (unistrut type) open web joist.

FIG. 35 depicts a cross section through a roll formed galvanized steel segmented (unistrut type) open web joist.

FIG. 36 depicts a cross section through a roll formed galvanized steel segmented (unistrut type) open web joist horizontal member with optional elevated horizontal roll formed channel.

FIG. 37A, 37B and 37C depicts perspective views of the three different configurations of the forth alternate galvanized steel segmented (uni strut type) open web joist embodiments, wherein FIG. 37A illustrates a roll formed galvanized steel segmented (unistrut type) open web joist horizontal member with bolted or welded construction, and FIG. 37B illustrates a roll formed galvanized steel segmented (unistrut type) open web joist horizontal member with optional top or bottom roll formed channel, and FIG. 37C illustrates the roll formed galvanized steel segmented (unistrut type) open web joist horizontal member with a deep center roll formed channel.

FIG. 38 depicts a side view of the preferred embodiment of a roll formed galvanized steel segmented (unistrut type) girder.

FIG. 39 depicts a cross section of a roll formed galvanized steel segmented (unistrut type) girder.

FIG. 40 depicts a cross section through a roll formed galvanized steel segmented (unistrut type) girder.

FIG. 41A, 41B and 41C depicts perspective views of the three different configurations of the preferred galvanized steel segmented (unistrut type) girder embodiments, wherein FIG. 41A illustrates a roll formed galvanized steel segmented (unistrut type) open web girder horizontal member with bolted or welded construction, and FIG. 41B illustrates a roll formed galvanized steel segmented (unistrut type) open web girder open web girder horizontal member with optional top or bottom rolled formed full length galvanized steel channel, and FIG. 41C illustrates a roll formed galvanized steel segmented (unistrut type) open web girder open web girder with optional elevated roll formed channel at the top or bottom.

FIG. 42 depicts a side view of first alternate embodiment of the roll formed galvanized steel segmented (unistrut type) girder.

FIG. 43 depicts a cross section through a roll formed galvanized steel segmented (unistrut type) girder.

FIG. 44 depicts a cross section through a roll formed galvanized steel segmented (unistrut type) girder.

FIG. 45A, 45B and 45C depicts perspective views of the three different configurations of the first alternate galvanized steel segmented (unistrut type) girder embodiments, wherein FIG. 45A illustrates a roll formed galvanized steel segmented (uni strut type) open web girder horizontal member with bolted or welded construction, and FIG. 45B is the roll formed galvanized steel segmented (unistrut type) open web girder horizontal member with optional top or bottom roll formed channel, and FIG. 45C is the roll formed galvanized steel segmented (unistrut type) open web girder horizontal member with optional elevated channel at the top or bottom.

FIG. 46 depicts a side view of second alternate embodiment of the roll formed galvanized steel segmented (unistrut type) girder.

FIG. 47 depicts a cross section through a roll formed galvanized steel segmented (unistrut type) girder.

FIG. 48 depicts a cross section through a roll formed galvanized steel segmented (unistrut type) girder with the elevated roll formed channel.

FIG. 49A, 49B and 49C depicts perspective views of the three different configurations of the second alternate embodiment of the galvanized steel segmented (unistrut type) girders, wherein FIG. 49A illustrates a roll formed galvanized steel roll formed segmented open web girder horizontal member with bolted or welded construction, and. FIG. 49B illustrates a roll formed galvanized steel segmented (unistrut type) open web girder horizontal member with optional top or bottom roll formed channel, and FIG. 49C illustrates a roll formed galvanized steel segmented (uni strut type) open web girder horizontal member with optional elevated roll formed channel at the top or bottom.

FIG. 50 depicts a side view of third alternate embodiment of the roll formed galvanized steel segmented (unistrut type) girder.

FIG. 51 depicts a cross section through a galvanized steel channel (unistrut type) vertical member with optional top or bottom horizontal channel full length.

FIG. 52 depicts a cross section through a roll formed galvanized steel segmented (unistrut type) girder.

FIG. 53A, 53B and 53C depicts perspective views of the three different configurations of the third alternate embodiments, wherein FIG. 53A illustrates a roll formed galvanized steel segmented (uni strut type) open web girder open web girder horizontal member with bolted or welded construction, and FIG. 53B illustrates a roll formed galvanized steel segmented (unistrut type) open web girder open web girder horizontal member with optional top or bottom roll formed channel, and FIG. 53C illustrates a roll formed galvanized steel segmented (unistrut type) open web girder horizontal member with optional elevated roll formed channel at the top or bottom.

FIG. 54 depicts a plan view of the Large Enclosed Secure Greenhouse Structure with the roof removed over the greenhouse area detailing the office area, compartmentalized planting growing areas, decontamination rooms, secured hallways and loading dock locations.

### DETAILED DESCRIPTION OF THE PREFERRED EMBODIMENTS

As required, the detailed embodiments of the present Large Enclosed Secure Greenhouse Structures 10A and 10B are disclosed herein, however, it is to be understood that the disclosed embodiments are merely exemplary of the design that may be embodied in various forms. Therefore, specific functional and structural details disclosed herein are not to be interpreted as limiting, but merely as basic for the claims and as a representative basis for teaching one skilled in the art to variously employ the present design in virtually any appropriately detailed structure.

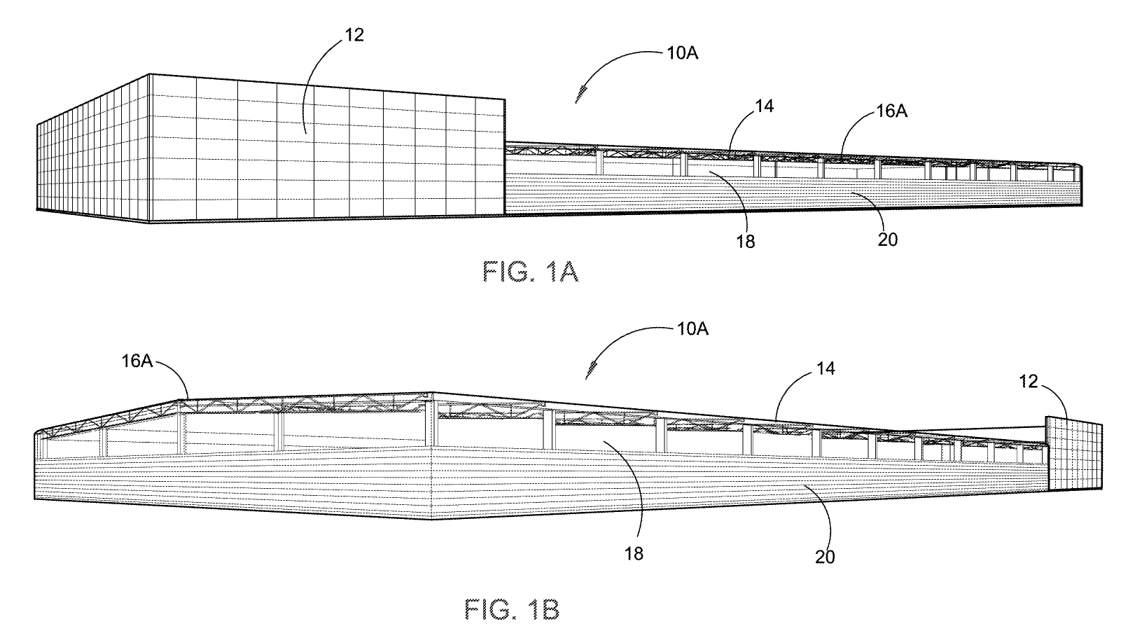

FIG. 1A depicts a perspective view of a front to side elevation of the large low pitched flat roof Enclosed Secure Greenhouse Structure 10A with the enclosed multi-purpose office area 12. The green house section 14 that extends to the back with a transparent pitched roof 16A with transparent upper side walls 18 and solid lower side walls 20.

FIG. 1B depicts a perspective view of the rear to side elevation of the large low pitched flat roof Enclosed Secure Greenhouse Structure 10A with the enclosed multi-purpose office are 12. The green house section 14 extends to the back with a transparent domed roof 169, transparent upper side walls 18 and solid lower side walls 20.

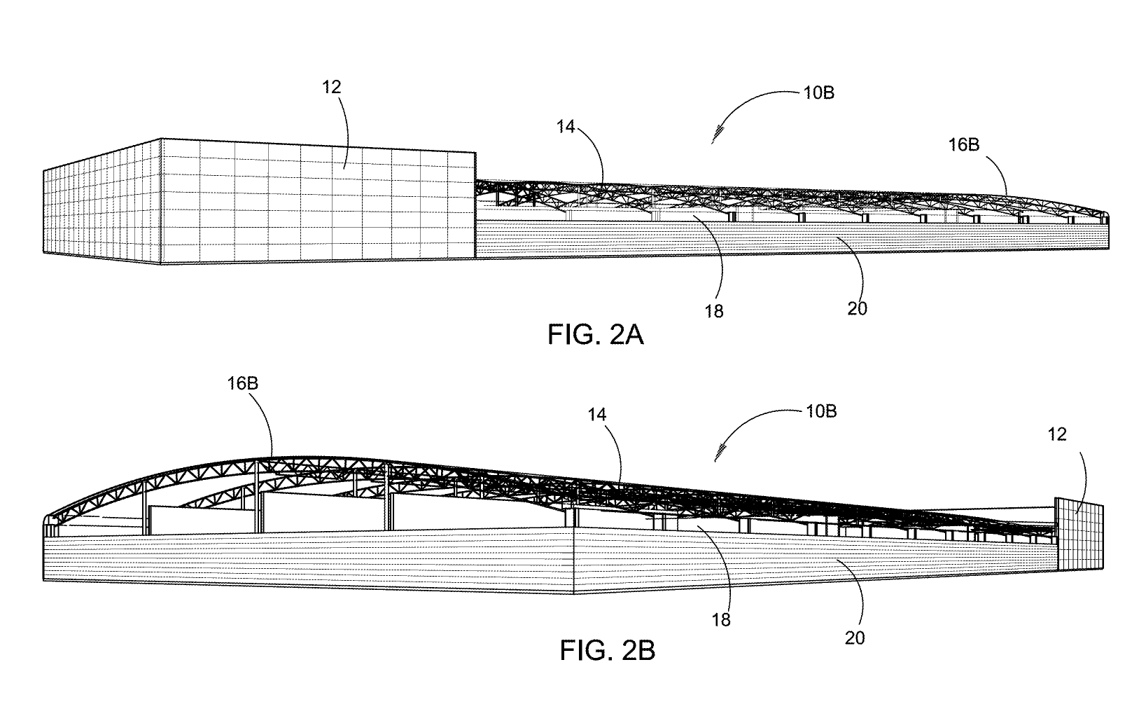

FIG. 2A depicts a perspective view of a front to side elevation of the large domed roof of the Enclosed Secure Greenhouse Structure 10B with the enclosed multi-purpose office area 12. The green house section 14 extends to the back with a transparent domed roof 16B, transparent upper side walls 18 and solid lower side walls 20.

FIG. 2B depicts a perspective view of the rear to side elevation of the large domed flat roof Enclosed Secure Greenhouse Structure 10B with the enclosed multi-purpose office area 12. The green house section 14 extends to the back with a transparent domed roof 16B, transparent upper side walls 18 and solid lower side walls 20.

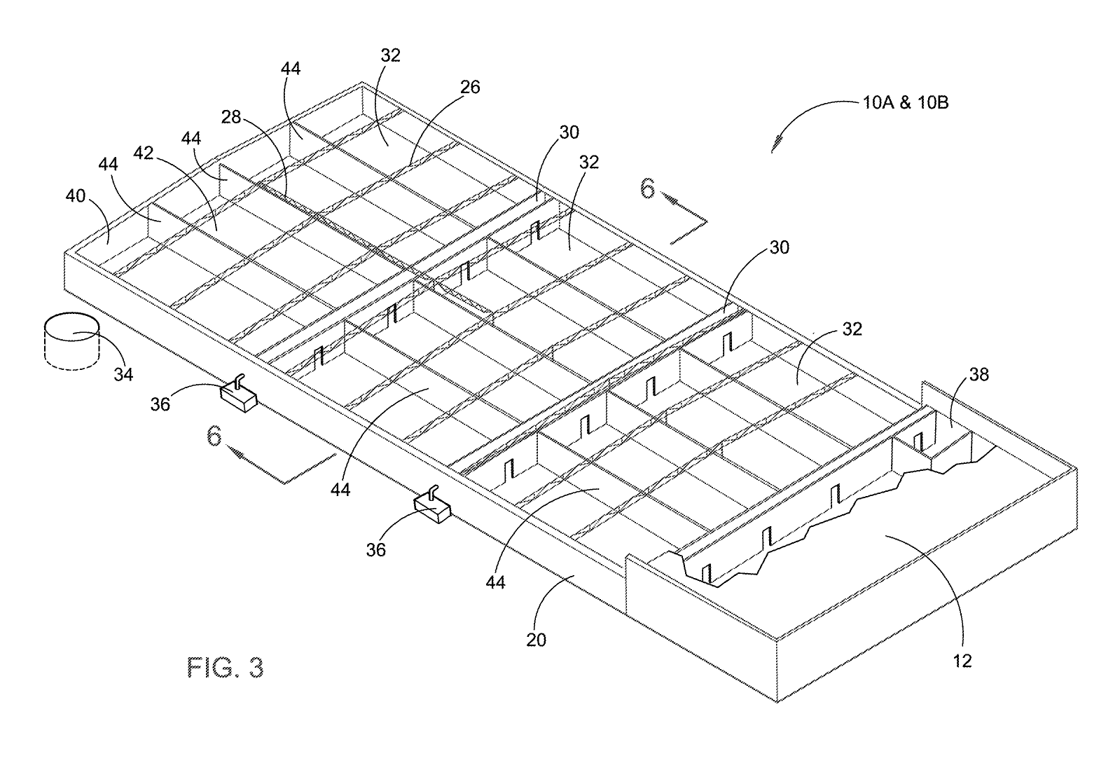

FIG. 3 depicts a perspective schematic of the interior components of the large Enclosed Secure Greenhouse Structures 10A and 10B illustrating the primary open web segmented girder system 26 and a portion of the secondary open web segmented open web joist system 28 which will be evenly spaced at five feet or the width of the roof panels. One or more sealed hallways 30 separate the compartmentalized primary growing areas 32. An underground or above ground water retention container 34 will hold rain water to possibly be used for irrigation purposes. Air handlers and air filtration systems 36 will be placed outside the solid lower side walls 20 as required. The multipurpose office structure 12 will house a separate clean room 38 along with office spaces, maintenance area dry product storage and a shipping department. All the interior walls 40 and floor 42 will be coated with a light reflecting material and one or more divider walls 44 will separate the compartmentalized primary growing areas 32.

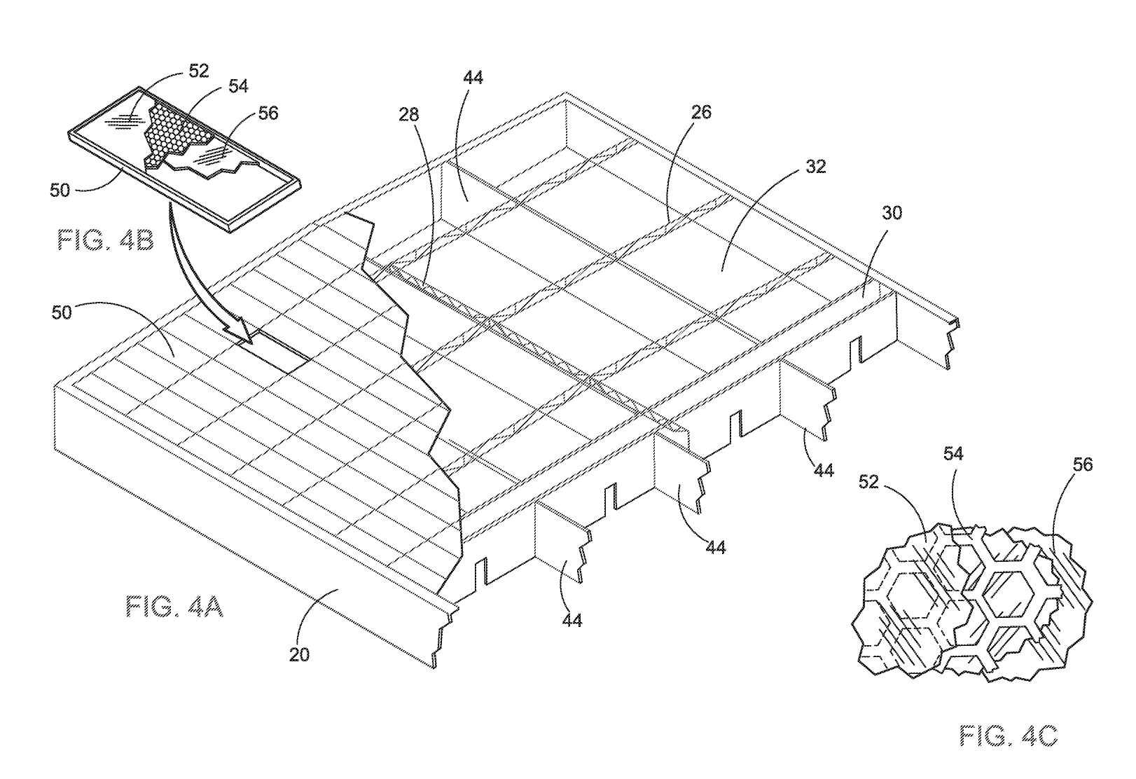

FIG. 4A depicts a perspective of a rear portion of the Large Enclosed Secure Greenhouse Structures 10A and 10B illustrating the installation of a typical roof or wall panel 50 having an upper transparent surface 52, an inner imbedded reinforcing material 54 and a lower transparent material 56.

FIG. 4B depicts a perspective top view of a single optional laminated transparent reinforced panel material having an upper transparent surface 52, an inner imbedded reinforcing material 54 and a lower transparent material 56. FIG. 4C depicts a partially broken away detail view of a roof panel, illustrating a close-up of the upper transparent surface 52, the inner imbedded reinforcing material 54 and the lower transparent material 56.

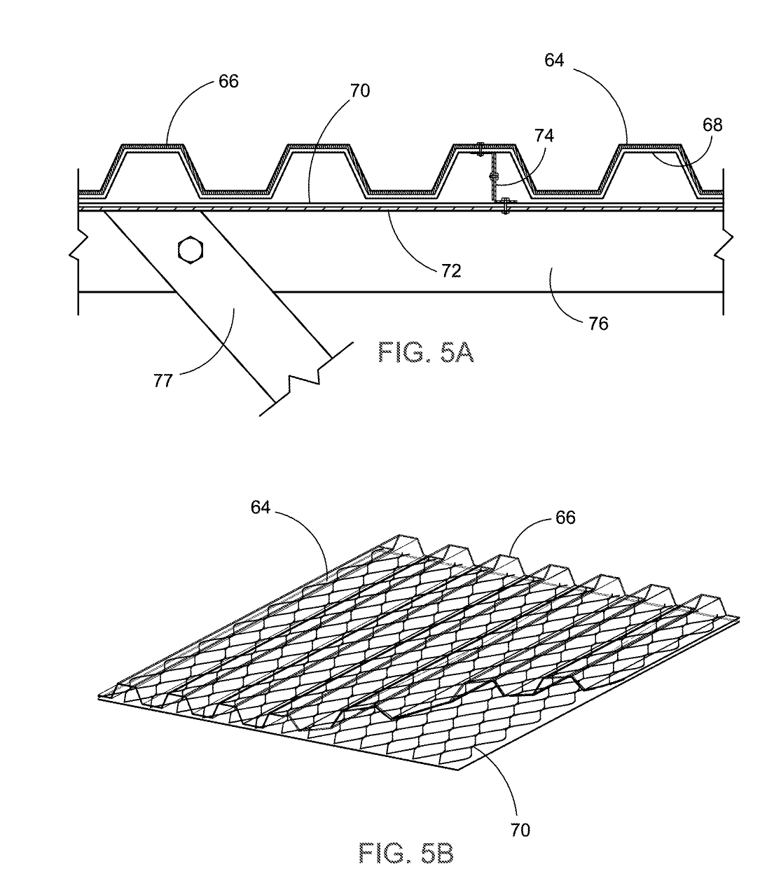

FIG. 5A depicts an edge view of the multi-layer transparent panel 64 where it will have reinforcement from transparent fiberglass polycarbonate or equal segments, with the top surface being a transparent single skin panel 66 having multiple shapes with its lower surface to be rolled formed wire or fiber mesh or open perforated metal panel 68 to match the panel profile and be laminated or mechanically fastened to the single skin panel 66. The top surface of the lower multi-layer transparent panel 64 will have optional flat wire or fiber mesh or an open perforated metal panel 70 laminated or mechanically attached to the single skin panel 66. The bottom of the lower multi-layer transparent panel 64 will have a fiat transparent panel 72 laminated or mechanically attached to perforated metal panel 70. The entire panel assembly rests on joist 76 which is supported by bolted on joist angle support member 77. The transparent single skin panel 66 is fastened to the bottom of flat transparent panel 72 and the top chord of joist 76 using a specialized z clip 74. This z clip 74 could be configured in a one-piece or multiple piece configuration, such as here showing two L shaped pieces bolted together at the center portion. The top of the z clip is positioned and secured to the high rib portions of the transparent panel 66 to prevent leaking when water is present in the trough portions.

FIG. 5B depicts a perspective view of the multi-layer transparent panel 64 reinforcement with transparent fiberglass polycarbonate or equal for roof or wall panels with the top surface being a transparent single skin panel 66 and bottom will consist of optional flat wire or fiber mesh or an open perforated metal panel 70.

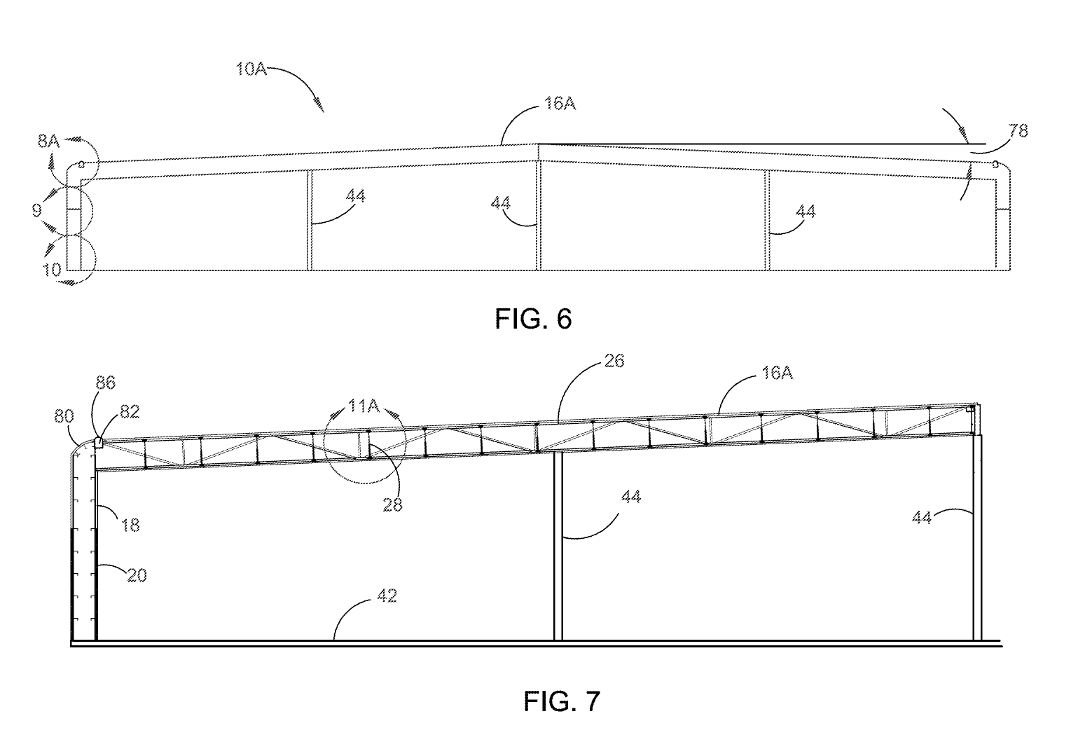

FIG. 6 depicts a cross section through the Large Enclosed Secure Greenhouse Structure 10A with the transparent pitched roof 16A. The pitch angle 78 can vary and still be within the scope of this application.

FIG. 7 depicts a cross section of one half of the Large Enclosed Secure Greenhouse Structure 10A illustrating the solid lower side wall 20 configuration and the transparent upper side wall 18 configuration. The curved edge 80 and enclosed rain gutter 82 are continuous on the three sides of pitched roof 16A on the green house section 14.

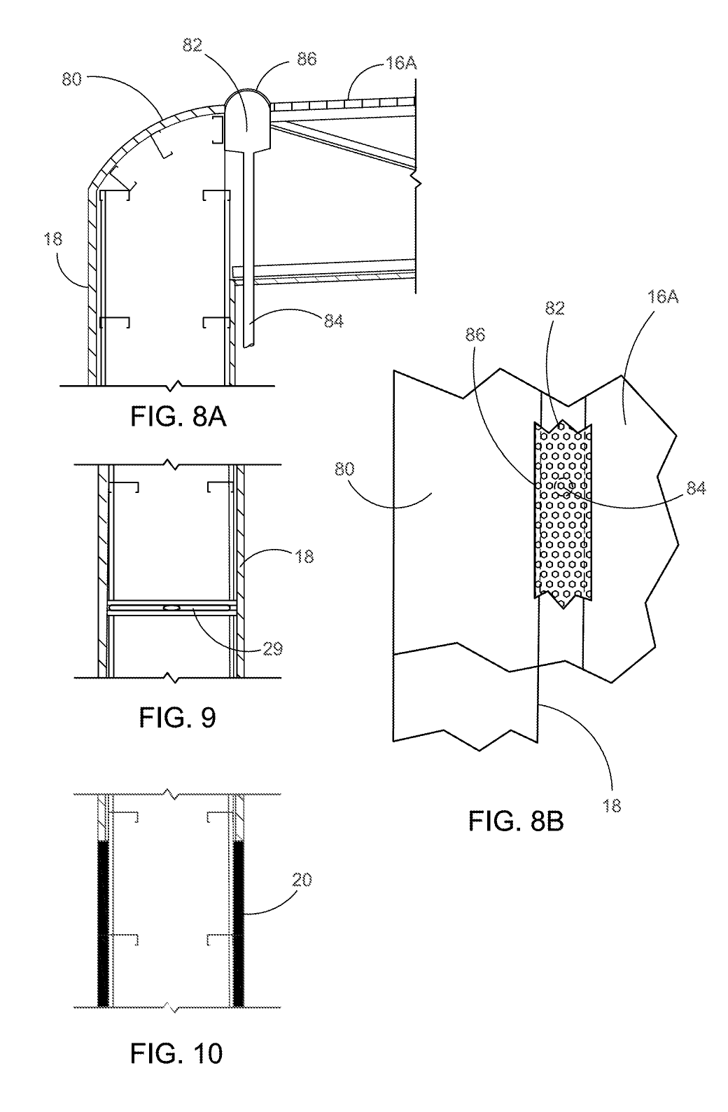

FIG. 8A depicts a side view of the greenhouse curved edge 80 of the pitched roof 16A and upper transparent side wall 18 where the rain gutter 82 has the drain line 84 that goes down into the inside to be connected to the water retention container 34 outside the building. A plurality of snow diverters 86 will extend out over the rain gutter to keep the snow from hanging up at the edge of the structure. Additionally, the heat of the building keeps the rain gutter drain lines 84 open when it is snowing.

FIG. 8B depicts a plan view of a section of the greenhouse curved edge 80 of the pitched roof 16A and upper side wall 18 where the rain gutter 82 has the drain line 84 that goes down into the inside to be connected to the water retention container 34 outside the building. The plurality of perforated snow diverters 86 extend out over the rain gutter and keep the snow from hanging up at the edge of the structure

FIG. 9 depicts a side view of the greenhouse transparent upper side wall 18 construction.

FIG. 10 depicts a side view of the greenhouse solid lower side wall 20 construction.

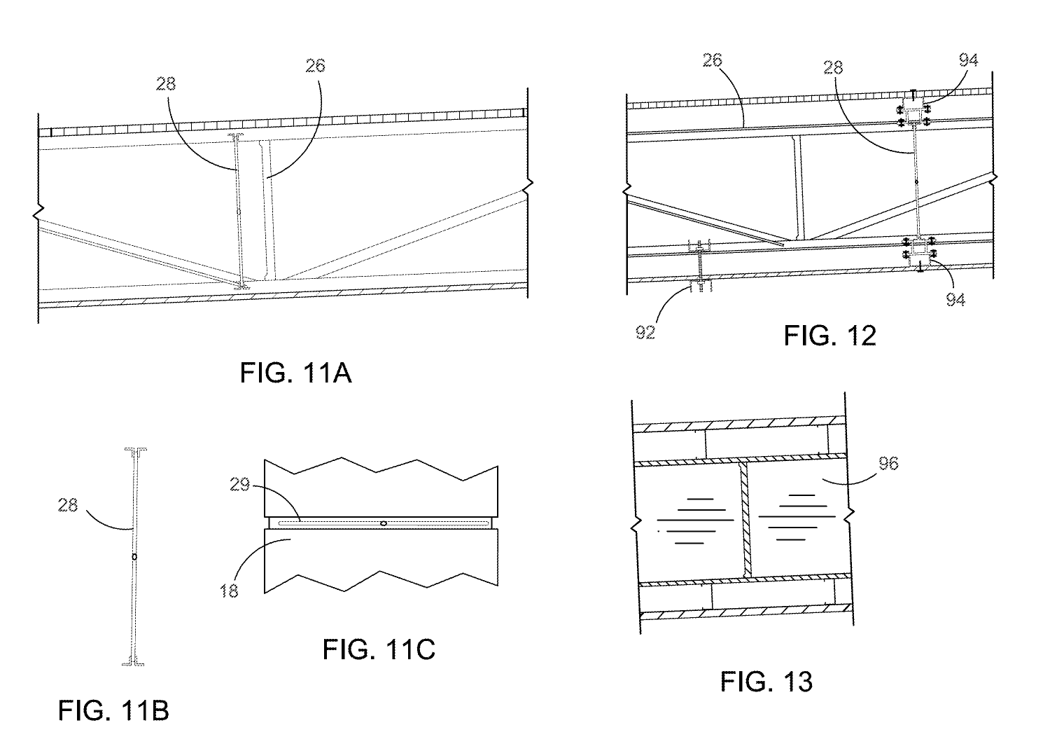

FIG. 11A depicts a side view of a portion of the segmented girder 26 with a segmented open web joist 28 in position.

FIG. 11B depicts a segmented open web joist 28 in the conventional vertical position.

FIG. 11C depicts a segmented fiat open web joist 29 in a horizontal position to be used as a structural reinforcement member in wall 18 construction.

FIG. 12 depicts side view of a portion of the segmented girder 26 with the utility ceiling spacer mounting bracket 92 and segmented open web joist bracket 28 incorporating the roof and ceiling spacer brackets 94.

FIG. 13 depicts a side view of a conventional steel open web girder 96,

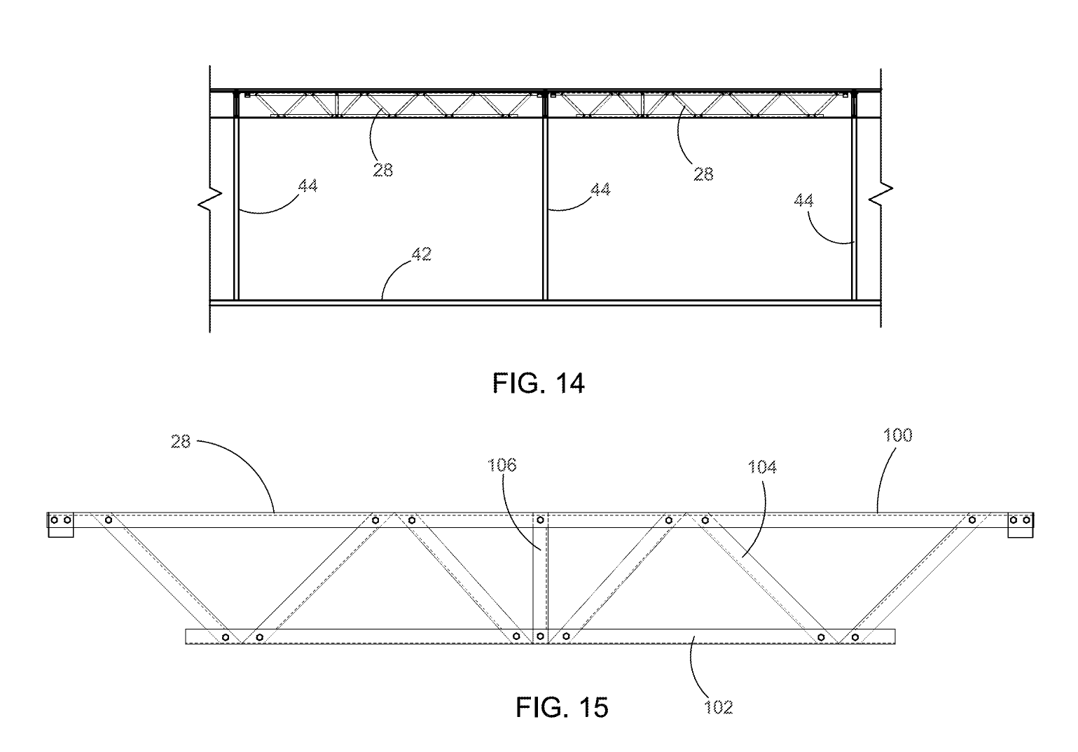

FIG. 14 depicts a side view of two segmented open web joists 28 spanning between room divider walls 44.

FIG. 15 depicts a side view of a typical segmented open web joist 28 with the horizontal upper extruded member 100 and lower extruded member 102 bolted or welded together with angled support members 104 and vertical support members 106.

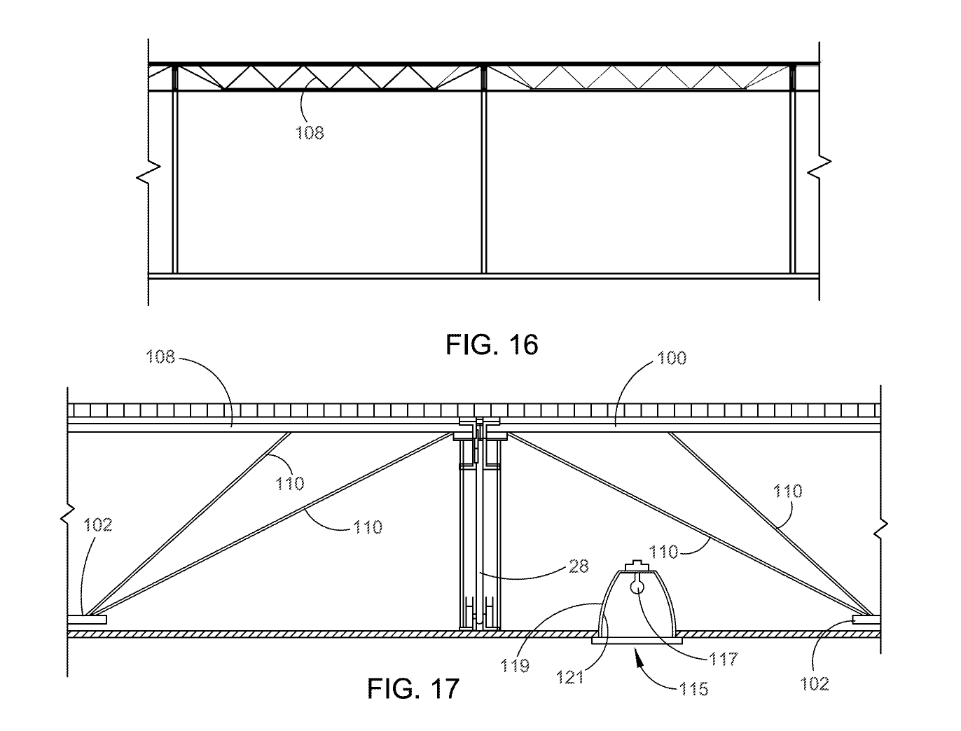

FIG. 16 depicts a side view of two segmented open web bar joists 108 spanning between room divider walls 44.

FIG. 17 depicts a side view of two segmented open web bar joists 108 with upper extruded angled members 100 and lower extruded members 102 welded together with a plurality of channel angled support bars 110. Additionally, there is shown the installation of a typical light fixture assembly 115 having a light bulb 117, a transparent housing 119 to allow daylight to pass through during daylight hours, and a reflective underside coating 121 to reflect and amplify the light emanating from the light bulb 117 during dark hours, as required for the optimum growth of plants. In this way, it is anticipated that all lighting fixtures will have transparent shrouds to allow sunlight passage during daylight hours. The underside of the transparent lighting shrouds will have a transparent reflective coating to provide maximum light output by the lightbulb.

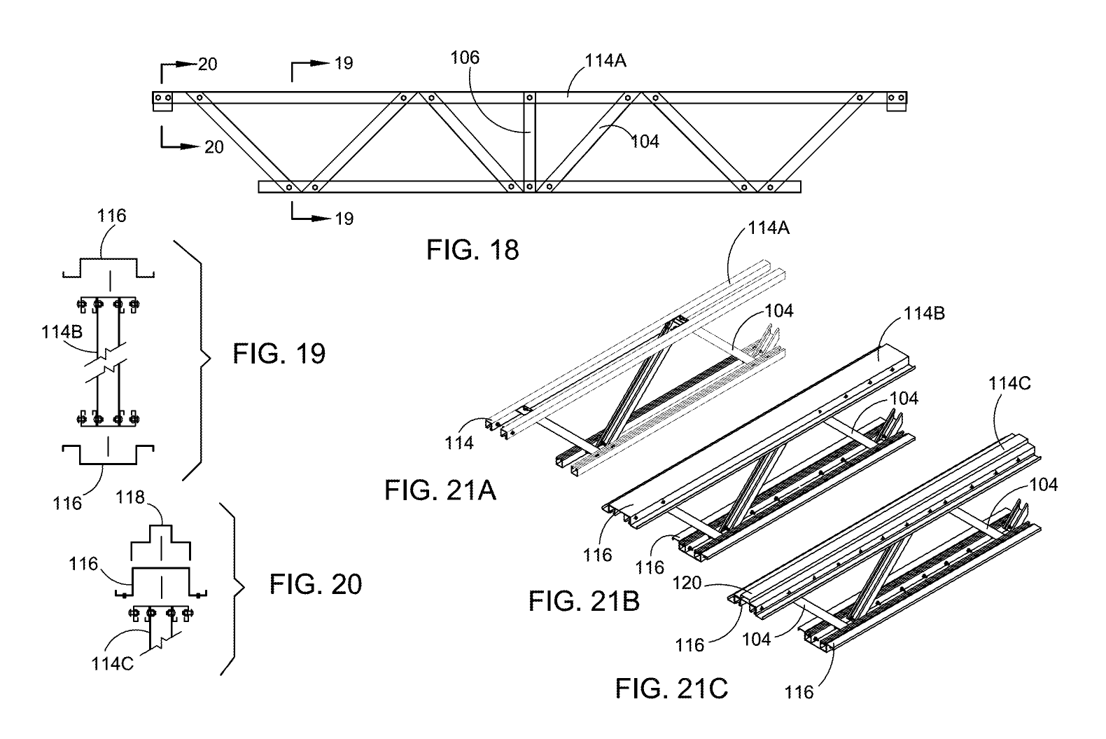

FIG. 18 depicts a side view of the preferred embodiment of the roll formed galvanized steel segmented (unistrut type) open web joist 114A with bolted or welded construction with single row angled support members 104 and vertical support members 106. Also illustrated in FIG. 18 is the special roof and wall joist with bottom chord hinged stabilizers 107 and 111 capable of hinging movement upward or downward to contact the bottom of the support beam or girder 105. Furthermore, the bottom chord hinged stabilizers 111 include a moveable sliding joint 109 connection which can slide back and forth into or out of the main stationary bottom chord to allow for live load or dead load joist deflection. All joist will be constructed of galvanized metal and all joist will be coated with a light reflecting coating.

FIG. 19 depicts a cross section through the roll formed galvanized steel segmented (unistrut type) open web joist 114B member with optional top or bottom roll formed channel 116 full length for additional sideway control over top chord 118.

FIG. 20 depicts a cross section through the roll formed galvanized steel segmented (unistrut type) open web joist 114C member with optional top or bottom roll formed channel 116 and the elevated roll formed channel 120 at top or bottom for roof or ceiling movement due to contraction and expansion.

FIG. 21A, 21B and 21C depicts perspective views of the three different configurations of the preferred joist embodiment with the first view shown in FIG. 21A being the roll formed galvanized steel segmented (unistrut type) open web joist 114A horizontal member with a second view shown in FIG. 21B being the roll formed galvanized steel segmented (unistrut type) open web joist 114B member with optional top or bottom roll formed channels 116 full length for additional sideway control over top chord 118. A third view shown in FIG. 21C being the roll formed galvanized steel segmented (unistrut type) open web joist 114C member with elevated roll formed channel 120 at the top or bottom over roll formed channel 116 for roof or ceiling movement due to contraction or expansion.

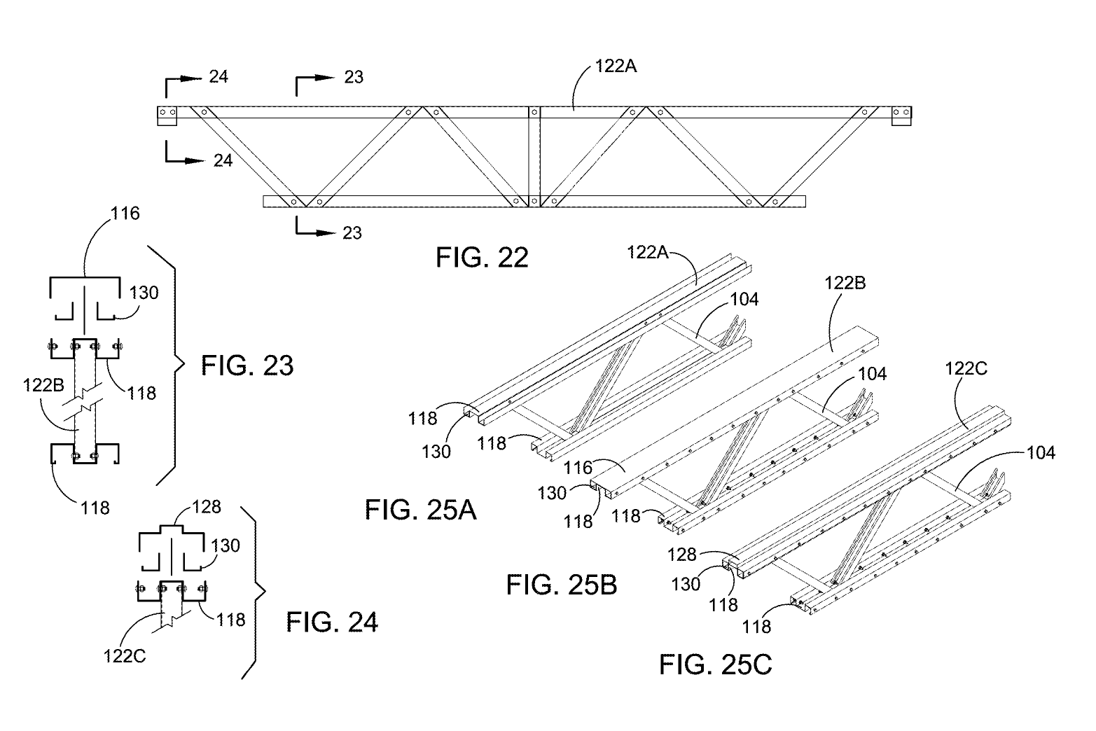

FIG. 22 depicts a side view of the first alternate embodiment of the roll formed galvanized steel segmented (unistrut type) open web joist 122A having a bolted or welded construction with a single row of angled support members 104 and vertical support members 106.

FIG. 23 depicts a cross section through a roll formed galvanized steel segmented (unistrut type) open web joist 1228 member with optional top roll formed channel 116 full length for sideways control over top or bottom chord 118 with angled support members 104 and channel 126.

FIG. 24 depicts a cross section through a roll formed galvanized steel segmented (unistrut type) open web joist 122C member with optional elevated channel 128 at top or bottom for roof or ceiling movement due to contraction and expansion. Mounting angles 130 will be bolted or welded to beam with a special one-piece roll formed top and bottom chord 118.

FIG. 25A, 25B and 25C depicts perspective views of the three different configurations of the first alternate joist embodiment with the first view shown in FIG. 25A being the roll formed galvanized steel segmented (uni strut type) open web joist 122A horizontal member with bolted or welded construction with single row angled support members 104 and vertical support members 106. The second view shown in FIG. 25B being a basic steel galvanized roll formed channel (unistrut type) segmented open web joist 122B with optional top channel being full length for sideways control over top or bottom chord 118 and the third view shown in FIG. 25C being the basic galvanized steel roll formed channel (unistrut type) horizontal segmented open web joist 122C with elevated roll formed channel at the top or bottom for roof or ceiling movement due to contraction and expansion.

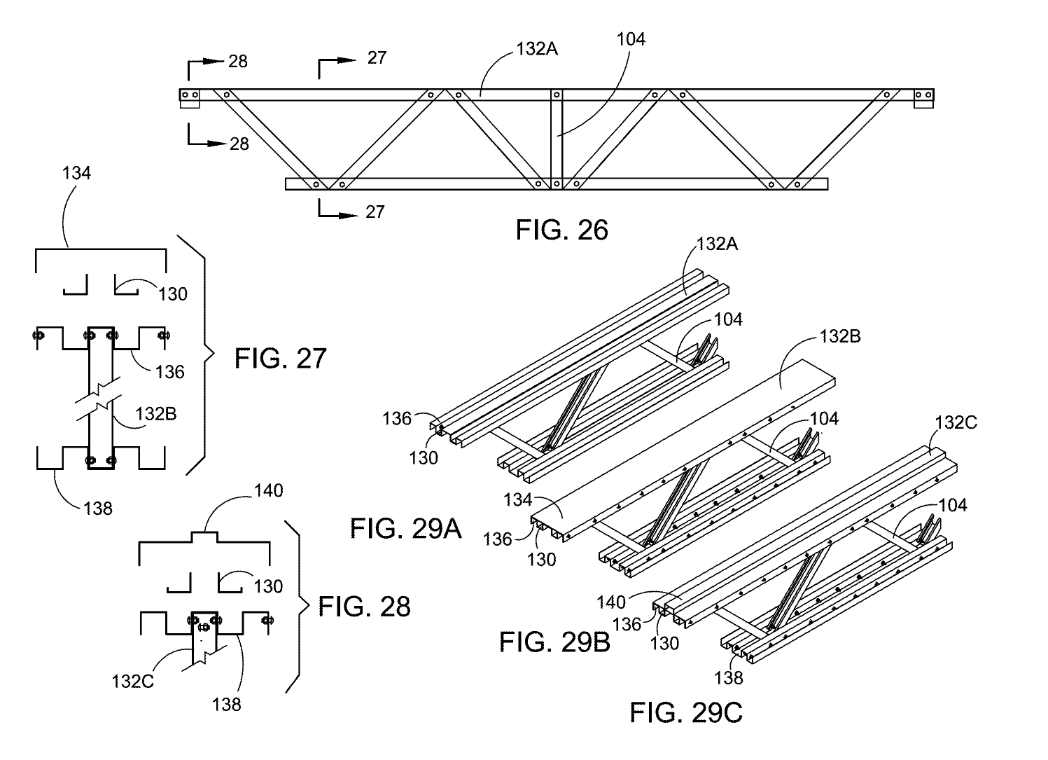

FIG. 26 depicts a side view of the second alternate embodiment of the roll formed galvanized steel segmented (unistrut type) open web joist 132A having a bolted or welded construction with a single row of angled support members 104 and vertical support members 106.

FIG. 27 depicts a cross section through a roll formed galvanized steel segmented (unistrut type) open web joist 132B member with optional top or bottom roll formed channel 134 full length for additional sideway control over a special one-piece roll formed top chord 136 or bottom chord 138. Mounting angles 130 or preformed top section will be bolted or welded to beam.

FIG. 28 depicts a cross section through a roll formed galvanized steel segmented (unistrut type) segmented open web joist 132C member with optional elevated roll formed channel 140 at top or bottom for roof or ceiling movement due to contraction or expansion. Mounting angles 130 or preformed top section will be bolted or welded to beam with a special one-piece roll formed for top cord 136 and bottom chord 138.

FIG. 29A, 29B and 29C depicts perspective views of the three different configurations of the second alternate joist embodiment where the first view shown in FIG. 29A is the roll formed galvanized steel segmented (unistrut type) open web joist 132A having a bolted or welded construction with single row angled support members 104 and vertical support members 106. The second view shown in FIG. 29B is the roll formed galvanized steel segmented (unistrut type) open web joist 132B horizontal member with optional top or bottom roll formed channel 134 full length for additional sideway control over a special one piece roll formed top chord 136 and bottom chord 138 and the third view shown in FIG. 29C is the roll formed galvanized steel segmented (uni strut type) open web joist 132C member with optional elevated roll formed galvanized channel 140 at top or bottom for roof or ceiling movement due to contraction or expansion. A mounting angle 130 or preformed top section will be bolted or welded to beam with a special one-piece roll formed for top chord 136 and bottom chord 138.

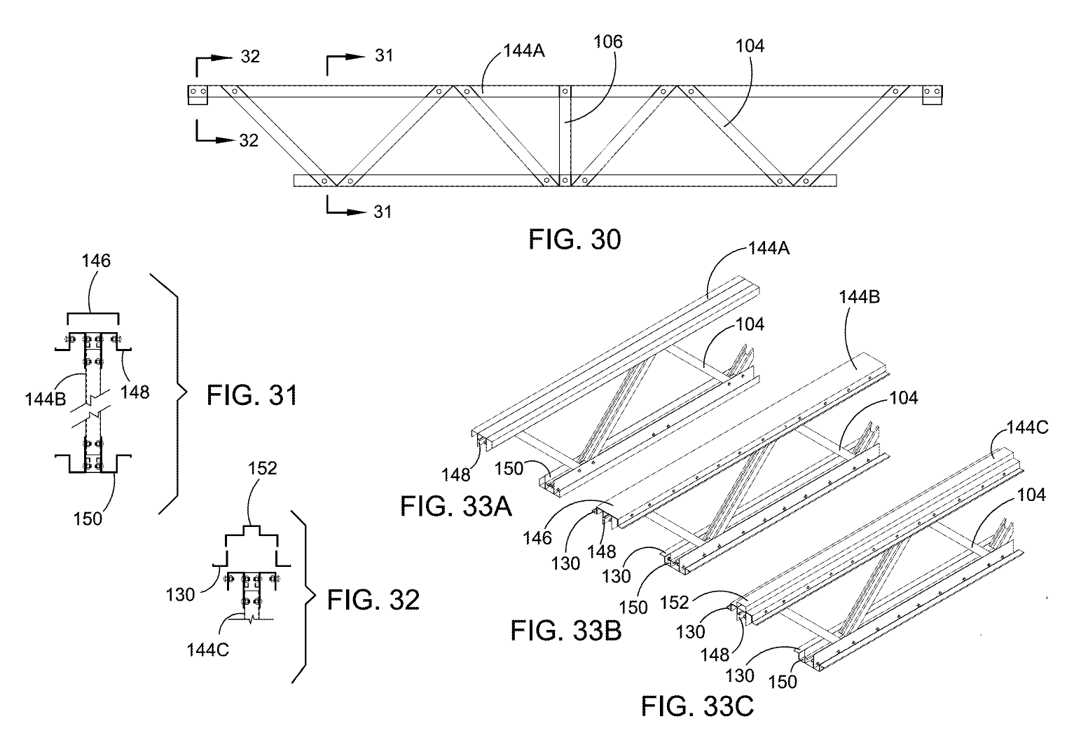

FIG. 30 depicts a side view of the third alternate embodiment of the roll formed galvanized steel segmented (unistrut type) open web joist 144A with bolted or welded construction with single row angled support members 104 and vertical support members 106.

FIG. 31 depicts a cross section through a roll formed galvanized steel segmented (unistrut type) joist 144B member with optional top or bottom roll formed channel 146 full length for additional sideway control over extended top chord 148 or extended bottom chord 150.

FIG. 32 depicts a cross section through a roll formed galvanized steel segmented (unistrut type) open web joist 144C member with optional elevated roll formed channel 152 at top or bottom for roof or ceiling movement due to contraction or expansion with mounting angles 130 or preformed top section bolted or welded to beam. An added leg for strength will added to the top chord 148 and bottom chord 150.

FIG. 33A, 33B and 33C depicts perspective views of the three different configurations of the third alternate joist embodiment where the first view shown in FIG. 33A is the roll formed galvanized steel segmented (unistrut type) open web joist 144A with bolted or welded construction and with a single row of angled support members 104. The second view shown in FIG. 33B is the roll formed galvanized steel segmented (unistrut type) open web joist 144B horizontal member with optional top or bottom roll formed channel 146 full length for additional sideway control over top chord 148 or bottom chord 150. The third view shown in FIG. 33C is the roll formed galvanized steel segmented (unistrut type) open web joist 144C member with optional elevated roll formed channel 152 at the top or bottom for roof or ceiling movement due to contraction or expansion. A mounting angle 130 or preformed top section will be bolted or welded to beam with a special one-piece roll formed section for top and bottom chord. An added leg for strength will be added to the extended top chord 154 and extended bottom chord 156.

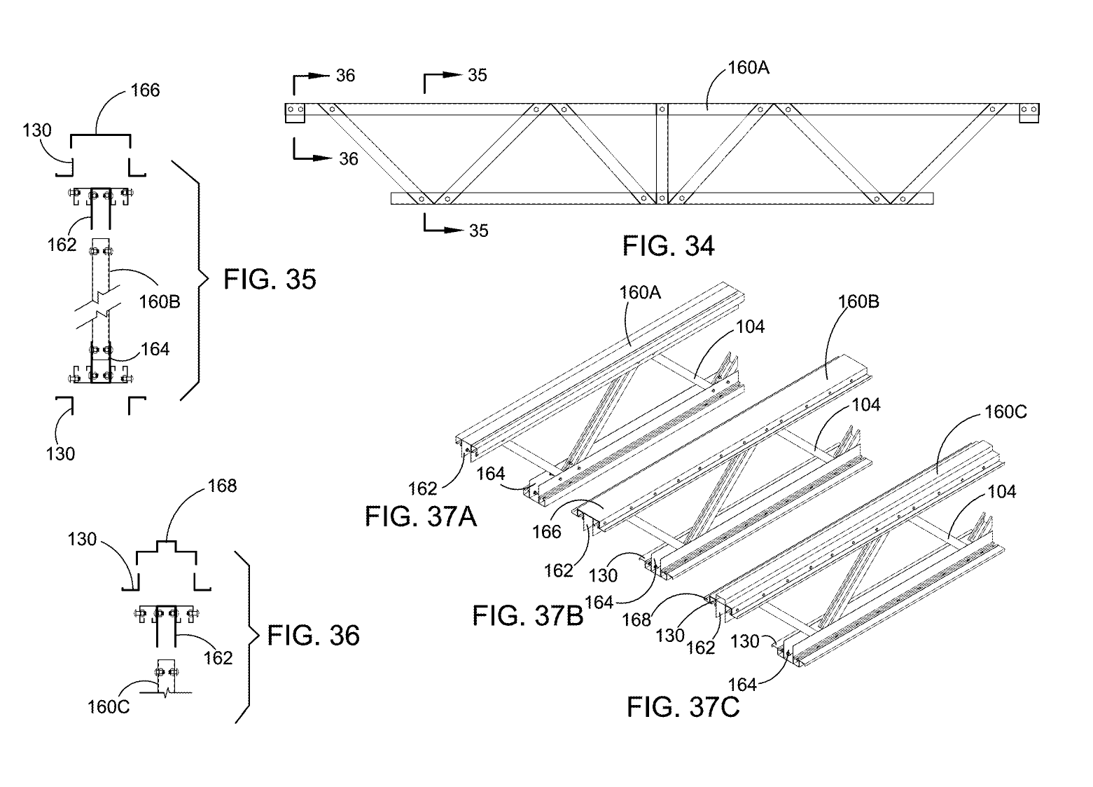

FIG. 34 depicts a side view of the forth alternate embodiment of the roll formed galvanized steel segmented (unistrut type) open web joist 160A with bolted or welded construction with single row angled support members 104 and vertical support members 106.

FIG. 35 depicts a cross section through roll formed galvanized steel segmented (unistrut type) open web joist 160B member with optional top or bottom roll formed channel 166 full length for additional sideway control over top or bottom chord. An added leg for strength will be added to the extended top chord 162 and extended bottom chord 164.

FIG. 36 depicts a cross section through a roll formed galvanized steel segmented (unistrut type) open web joist 160C member with optional elevated roll formed channel 168 at top or bottom for roof or ceiling movement due to contraction or expansion with mounting angles 130 or preformed top section bolted or welded to beam. An added leg for strength will be added to the extended top chord 162 and extended bottom chord 164.

FIG. 37A, 37B and 37C depicts perspective views of the three different configurations of the forth alternate joist embodiment where the first view shown in FIG. 37A is the roll formed galvanized steel segmented (unistrut type) open web joist 160A horizontal member with bolted or welded construction and single row of angled support members 104. The second view shown in FIG. 37B is a roll formed galvanized steel segmented (unistrut type) open web joist 160B horizontal member with optional top or bottom roll formed channel 166 full length for additional sideway control over extended top chord 162 or extended bottom chord 164. The third view shown in FIG. 37C is the roll formed galvanized steel segmented (unistrut type) open web joist 160C horizontal member with a deep center roll formed channel 168 for strength in extended top chord 162 and extended bottom chord 164. Optional elevated roll formed 168 horizontal members are used at the top or bottom for roof or ceiling movement due to contraction or expansion. A mounting angle 130 or preformed top section will be bolted or welded to the beam.

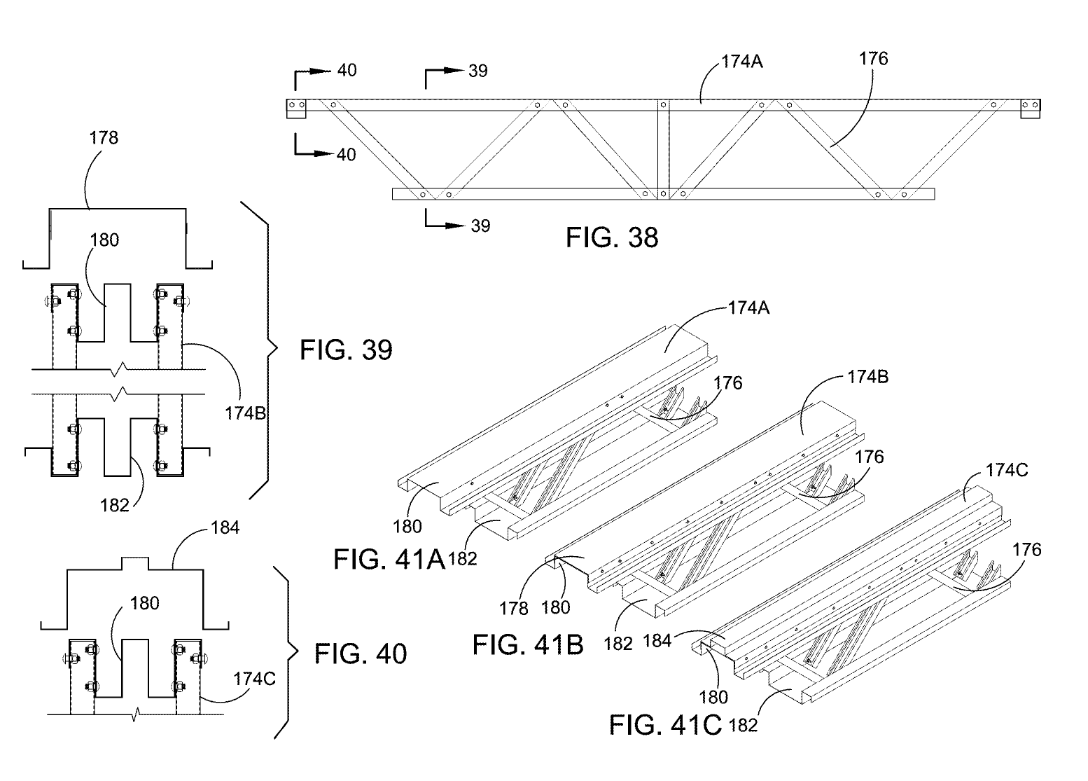

FIG. 38 depicts a side view of the preferred embodiment of a roll formed galvanized steel segmented (uni strut type) open web girder 174A horizontal member with bolted or welded construction having a double row of angled support members 176.

FIG. 39 depicts a cross section through a roll formed galvanized steel segmented (unistrut type) open web girder 174B horizontal member with optional top or bottom rolled formed full length galvanized steel channel 178 for additional sideway control over top chord 180 or bottom chord 182with a mounting angle or preformed top section bolted or welded to beam.

FIG. 40 depicts a cross section through a roll formed galvanized steel segmented (unistrut type) open web girder 174C horizontal member with optional elevated horizontal channel 184 at top or bottom for roof or ceiling movement due to contraction or expansion with a mounting angle 130 or preformed top section bolted or welded to beam.

FIG. 41A, 41B and 41C depicts perspective views of the three different configurations of the preferred joist embodiment where the first view shown in FIG. 41A is the roll formed galvanized steel segmented (unistrut type) open web girder 174A horizontal member with bolted or welded construction having a double row of angled supports 176. The second view shown in FIG. 41B is the roll formed galvanized steel segmented (unistrut type) open web girder open web girder 174B horizontal member with optional top or bottom rolled formed full length galvanized steel channel 178 for additional sideway control over top chord 180 or bottom chord 182. The third view shown in FIG. 41C is a roll formed galvanized steel segmented (unistrut type) open web girder open web girder 174C with optional elevated roll formed channel 184 at the top or bottom for roof or ceiling movement due to contraction or expansion with a mounting angle 130 or preformed top section bolted or welded to beam.

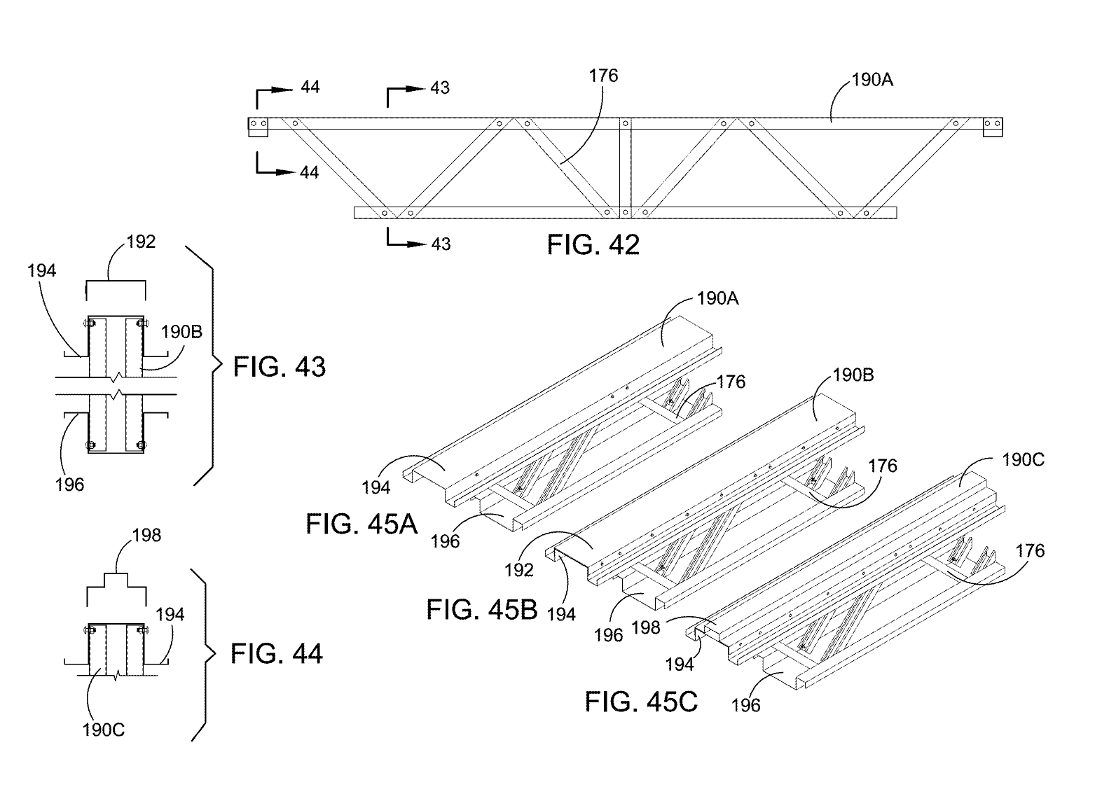

FIG. 42 depicts a side view of first alternate embodiment of the roll formed galvanized steel segmented (unistrut type) open web girder 190A horizontal member with bolted or welded construction having a double row of angled supports 176.

FIG. 43 depicts a cross section through a roll formed galvanized steel segmented (unistrut type) open web girder 190B horizontal member with optional top or bottom steel roll formed channel 192 full length for additional sideway control over top chord 194 or bottom chord 196 with an additional mounting angle 130 or preformed top section bolted or welded to the beam.

FIG. 44 depicts a cross section through a roll formed galvanized steel segmented (unistrut type) open web girder 190C horizontal member with optional elevated roll formed channel 198 at top or bottom for roof or ceiling movement due to contraction or expansion with an additional mounting angle 130 or preformed top section bolted or welded to the beam.

FIG. 45A, 45B and 45C depicts perspective views of the three different configurations of the first alternate joist embodiment where the first view shown in FIG. 45A is the roll formed galvanized steel segmented (unistrut type) open web girder 190A horizontal member with bolted or welded construction having a double row of angled supports 176. The second view shown in FIG. 45B is the roll formed galvanized steel segmented (unistrut type) open web girder 190B horizontal member with optional top or bottom roll formed channel 192 full length for additional sideway control over top chord 194 or bottom chord 196. The third view shown in FIG. 45C is the roll formed galvanized steel segmented (unistrut type) open web girder 190C horizontal member with optional elevated channel 198 at the top or bottom for roof or ceiling movement due to contraction or expansion with an additional angle 130 or preformed top section bolted or welded to the beam.

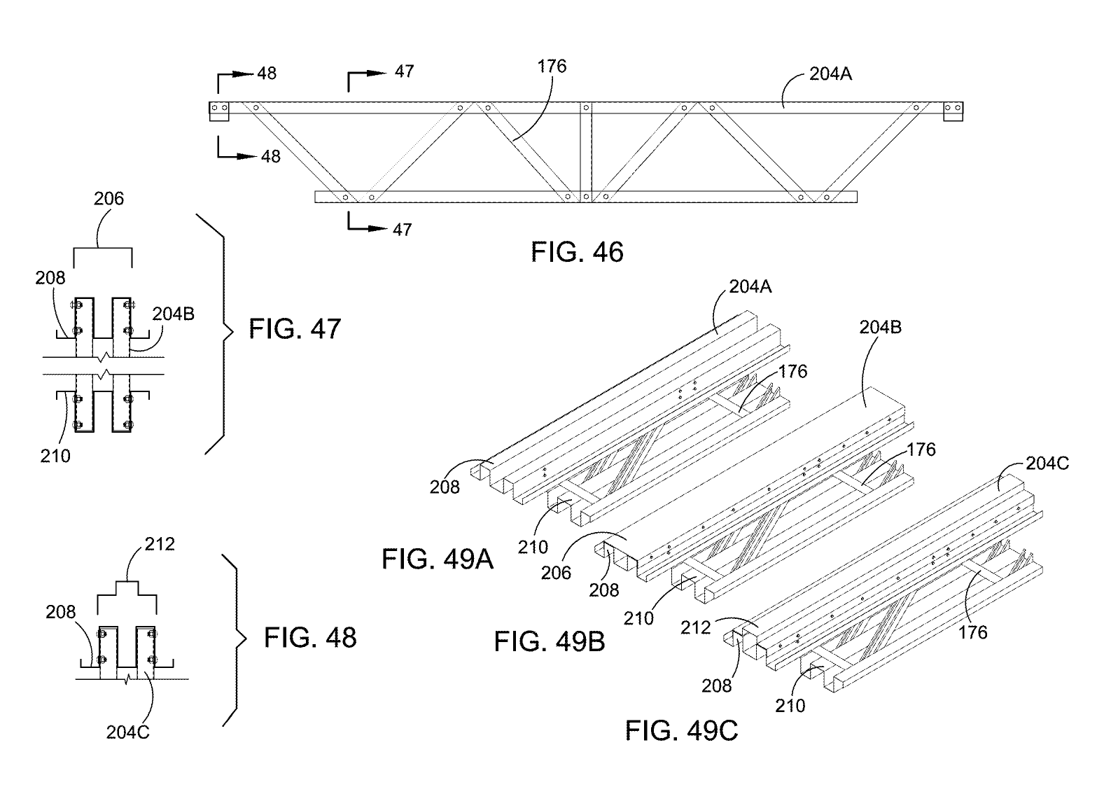

FIG. 46 depicts a side view of second alternate embodiment of the roll formed galvanized steel segmented (unistrut type) open web girder 204A horizontal member with bolted or welded construction having a double row of angled supports 176.

FIG. 47 depicts a cross section through a roll formed galvanized steel segmented (unistrut type) open web girder 204B horizontal member with optional top or bottom steel channel 206 full length for additional sideway control over top chord 208 or bottom chord 210 with an additional mounting angle or preformed top section bolted or welded to the beam.

FIG. 48 depicts a cross section through a roll formed galvanized steel segmented (unistrut type) open web girder 204C horizontal member with optional elevated steel roll formed channel 212 at top or bottom for roof or ceiling movement due to contraction or expansion with an additional mounting angle or preformed top section bolted or welded to the beam.

FIG. 49A, 49B and 49C depicts perspective views of the three different configurations of the second alternate joist embodiment where the first view shown in FIG. 49A is the roll formed galvanized steel roll formed segmented open web girder 204A horizontal member with bolted or welded construction having a double row of angled supports 176. The second view shown in FIG. 49B is the roll formed galvanized steel segmented (unistrut type) open web girder 204B horizontal member with optional top or bottom roll formed channel 206 full length for additional sideway control over top chord 208 or bottom chord 210. The third view shown in FIG. 49C is the roll formed galvanized steel segmented (unistrut type) open web girder 204C horizontal member with optional elevated roll formed channel 212 at the top or bottom for roof or ceiling movement due to contraction or expansion with an additional angle 130 or preformed top section bolted or welded to the beam.

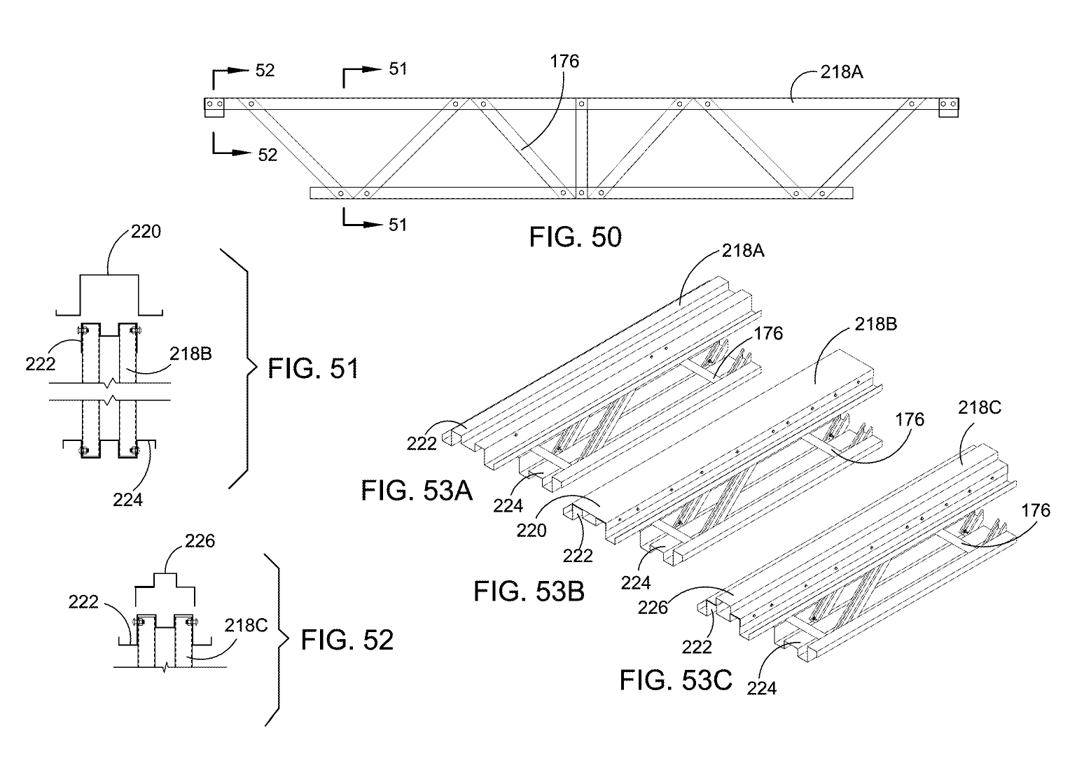

FIG. 50 depicts a side view of third alternate embodiment of the roll formed galvanized steel segmented (unistrut type) open web girder open web girder 218A horizontal member with bolted or welded construction having a double row of angled support members 176.

FIG. 51 depicts a cross section through a roll formed galvanized steel segmented (unistrut type) open web girder 218B horizontal member with optional top or bottom horizontal roll formed steel channel 220 full length for additional sideway control over top chord 222 or bottom chord 224 with an additional mounting angle 130 or preformed top section bolted or welded to the beam.

FIG. 52 depicts a cross section through a roll formed galvanized steel segmented (unistrut type) open web girder 218C horizontal member with optional elevated roll formed channel 226 full length at top or bottom for roof or ceiling movement due to contraction or expansion with an additional mounting angle 130 or preformed top section bolted or welded to the beam.

FIG. 53A, 53B and 53C depicts a depicts perspective views of the three different configurations of the third alternate joist embodiment where the first view shown in FIG. 53A is the roll formed galvanized steel segmented (unistrut type) open web girder open web girder 218A horizontal member with bolted or welded construction having a double row of horizontal supports. The second view shown in FIG. 53B is the roll formed galvanized steel segmented (unistrut type) open web girder open web girder 218B horizontal member with optional top or bottom roll formed channel full length for additional sideway control over top or bottom chord. The third view shown in FIG. 53C is the roll formed galvanized steel segmented (unistrut type) open web girder 218C horizontal member with optional elevated roll formed channel 220 at the top or bottom for roof or ceiling movement due to contraction or expansion with an additional angle 130 or preformed top section bolted or welded to the beam.

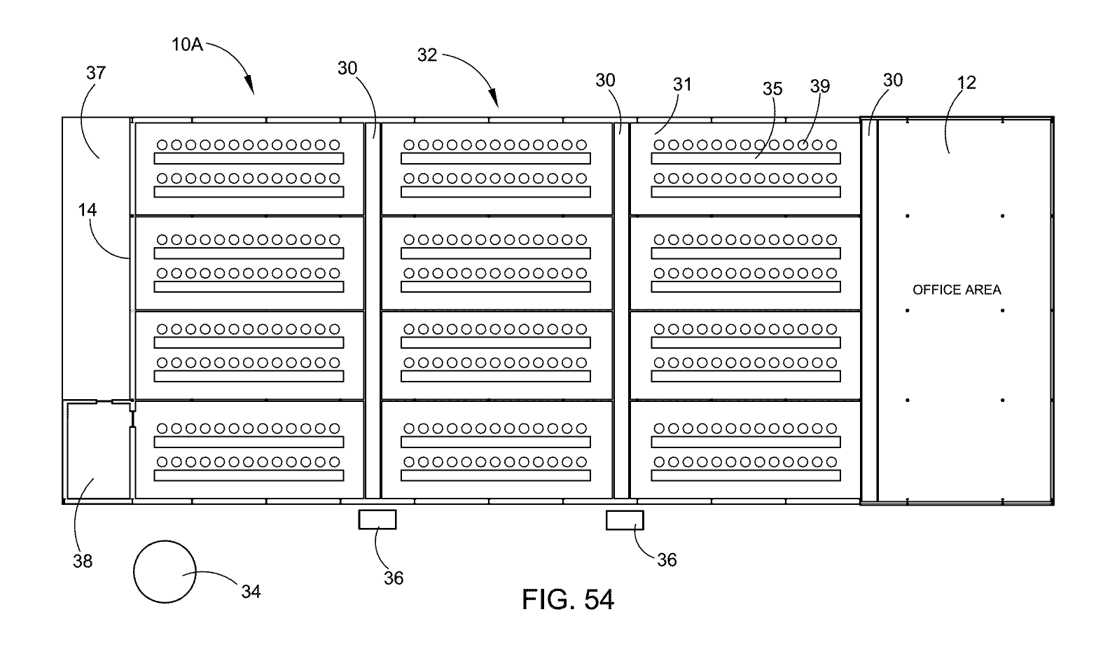

FIG. 54 depicts a plan view of the Large Enclosed Secure Greenhouse Structure 10A with the roof removed over the greenhouse area detailing the growing areas 32, sealed hallways 30, rain water retention container 34 and exterior location air handler and filtration systems 36. Also, shown is an optional truck loading dock area 37 having a decontamination room 38 adjacent to the loading dock 37. Additionally, in this FIG. 54 plan view of the Large Enclosed Secure Greenhouse Structure 10A, there is shown an array of twelve compartmentalized plant growing areas 32 as exemplified by single plant growing area 31 having numerous plants 39 therein and having plant growth enhancing lights 35 positioned below the plants to enhance growth.

### INDUSTRIAL APPLICABILITY

AGT Hybrid Greenhouse and Naturalite Buildings are designed as commercial and industrial buildings, complying with traditional aesthetic design criteria, are insulated, completely controlled interior environment including sunlight diffusion intensity, temperature, humidity and designed to perform in any climate condition.

All structural framing members to be galvanized, have reflective coating, are open web or solid web standard commercial structural shapes as defined in the most current issue of the Manuel of Steel Construction published by the American Institute of Steel Construction, Inc. and pre-engineered members as published in the Metal Building Manufacturers Association. Roofs are standard gable, segmented, hip or barrel shapes. The use of automatic roof water washing systems shall be employed on the roof to clean dust or related particles from the roof area. Specialty joist manufactured from pre-galvanized material are used with a proprietary full movement (in and out up and down) adjustable bottom chord braces which absorbs all joist deflection or uplift and a specialty structural member fastened to the joist bottom chord full length for installation of transparent ceiling panels and other ceiling mounted fixtures. Current greenhouse manufacture's existing proprietary structural design or member shapes are not used within these building systems.

Between the transparent roof and ceiling panels and exterior wall and interior wall panels there exists a continuous sealed air cavity. The air cavity runs from floor level at all walls and up throughout the entire roof area. The roof and wall sealed air cavities are connected and provide dead air space for insulation value. Roof or wall sealed air chambers are also used for return or intake air from the rooms below, circulated by oil bath fans and filters, eliminating traditional ductwork. Oil bath fans and filters are used to control infiltration of detrimental air borne particles and odor control within the structure.

All roof, wall and ceiling panels shall be transparent where required and may be manufactured from any transparent product. All transparent roof panels can incorporate perforated metal or wire mesh lamination or fiber underlayment's to protect from accidental fall through or damage of the transparent roof panels. Transparent roof panels to withstand all external roof loads prescribed by local municipal, state or federal building codes. All transparent panels are of single pane or multiple pane construction to include standing seam roof panels with an air chamber honey comb center sandwiched by a solid outer and inner transparent pane.

Controlling the amount of sunlight which enters the building are by the use of proprietary electrically vaporized/atomized/thermal enhanced liquids, fog, gases or smoke agents are injected into these areas for sunlight blocking and sunlight enhancement, use of cloth/fabric/rubber draping, adjustable mechanical louver systems and the use of electrochromic glass (smart glass) or equal products to electrically control the amount of light transmission at the wall, roof or ceiling panels to be used. Electrochromic glass or equal product can be electrically charged to change from clear to complete blackout including changing the insulation value.

Entire concrete floor, walls and ceiling sprayed with a reflective coating to reflect light and treated with a micro-bacterial coating eliminating bacteria, fungi, mold, etc. to grow on interior surfaces. Use reflective panels with grow lights positioned under plants to reflect or project light up under plant. All interior divider walls are transparent or solid to have reflective and micro bacterial coating. All individual rooms are sealed from each other room. This includes decontamination, office, recreation and warehouse rooms.

All lighting fixtures to have transparent shrouds to allow sunlight passage during daylighting hours. The underside of the transparent lighting shrouds shall have a transparent reflective coating to provide maximum light output by the lightbulb. All lighting systems can be on a light bar system over the plants. These light bar systems shall be on an electrically operated pulley system which can lower the entire light bar system in a position directly over the plants and can be adjusted upwards as the plant continues to grow. These light bars are typically used where low energy consumption lights are used but have a short effective range to induce plant growth. The light bar shrouds to be transparent.

Building shall have a rain water and melted snow water collection system with above or below ground water storage tanks. Roof mounted rain gutters shall have a specially designed rounded full-length perforated metal cover so that during periods of snow slides off of the roof, the internal rain gutter will not be damaged or restrict the sliding snow from movement off of the roof. Trench drains at ground level, along both sides of the buildings shall be used as a rain gutter and water collection system in lieu of roof mounted rain gutters.

Special thermal solar panels which super heat water, gases or oil to energize a power turbine generator engine to produce on site power for said building systems.

Proprietary tables which have an air plenum at the base which have holes in the top of the plenum for the plant pots to set into. Air or CO2 is then flowed through the air plenum which then distributes air and or CO2 evenly around the plant base, these grow tables also have their own light source on top and have transparent panels which skirt around the sides and directly over the top of the table. The air plenum moves up and down according to the plant growth in relation to the transparent top and light system.

Supplemental products used in the greenhouse structure shall include but is not limited to CPI Daylighting, Inc, IntelaSun, AWIP Panels Inc, Panelite, Kingspan Panels, Enduro FRP Panels, Amerilux International, Sabic Lexan Products, CrystaLite Inc., Saint-Gobain Glass Products, Sage Electrochromic Glass, Blue Scope Steel.

The Large Enclosed Secure Greenhouse Structure 10A and 10B shown in the drawings and described in detail herein disclose arrangements of elements of particular construction and configuration for illustrating preferred embodiments of structure and method of operation of the present design. It is to be understood, however, that elements of different construction and configuration and other arrangements thereof, other than those illustrated and described may be employed for providing a Large Enclosed Secure Greenhouse Structure 10A and 10B in accordance with the spirit of this application, and such changes, alternations and modifications as would occur to those skilled in the art are considered to be within the scope of this application as broadly defined in the appended claims.

Finally, it is anticipated that alternate pre-engineered metal building framing with pre-formed c and z secondary members as well as solid web rafters could be used, however, the use of these structural components would reduce the natural daylight and sunlight transmission through the resulting roof, if constructed in this fashion. Some of the supplemental products possibly used in the greenhouse structure include but not limited to CPI Daylighting, Inc. panels, Intelasun panels, AWIP Panels, Inc. panels, Panelite panels, Kingspan Panels panels, Enduro FRP Panels panels, Amerilux International panels, Crystalite, Inc. panels and Smart Tint and SmartGlass panels. Additionally, it is anticipated that special solar panels may be employed which super heat water or oil to energize a power turbine engine engaged to an electric generator to produce on site power for said greenhouse, allowing the Atrium/Hybrid greenhouse building to generate its own electrical power and potentially go off-grid.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. For example, one portion of one of the embodiments described herein can be substituted for another portion in another embodiment described herein. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also he implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Further, the purpose of the foregoing abstract is to enable the U.S. Patent and Trademark Office, foreign patent offices worldwide and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

I claim:

1. An atrium/hybrid multi-purpose greenhouse building, comprising:
(a) a base building structure having a multi-purpose area at one end and a greenhouse area at the opposite end;
(b) said base building structure having roof panels, ceiling panels, interior walls and exterior walls, and further including a roof located at the greenhouse area end;
(c) said roof and ceiling panels located at the greenhouse area end including roof and ceiling panels constructed of transparent polymer/transparent glass materials;
(d) said exterior walls of said greenhouse area end having a lower portion and an upper portion including exterior walls constructed of a solid non-transparent lower portion and a transparent upper portion;
(e) wherein said roof located at said greenhouse area end and said roof panels, ceiling panels and exterior wall panels are configured to include an airtight sealed chamber positioned between said roof panels and said ceiling panels and said exterior wall panels and said interior wall panels; and
further wherein said base building structure houses numerous compartmentalized multi-use areas, growing areas, secured hallways, decontamination rooms within said greenhouse area end and an office area within said multi-purpose area end.

2. The atrium/hybrid multi-purpose greenhouse building according to claim 1, wherein said airtight sealed chamber positioned between said roof panels and said ceiling panels and said exterior wall panels and said interior wall panels includes a continuous sealed air cavity which extends from floor level at all of said exterior walls up and throughout the entire roof area with said air cavity positioned between said roof panels and said ceiling panels.

3. The atrium/hybrid multi-purpose greenhouse building according to claim 2, wherein said sealed air cavity provides dead air space for insulation value as well as provides chambers for return or intake air circulated to and from the compartmentalized rooms within said greenhouse area end of the building.

4. The atrium/hybrid multi-purpose greenhouse building according to claim 3, wherein said return or intake air circulated to and from the compartmentalized rooms within said greenhouse area end of the building is circulated through oil bath, fans and filters used to control infiltration of detrimental air borne particles and odor control within said greenhouse area end of the building.

5. The atrium/hybrid multi-purpose greenhouse building according to claim 1, wherein said base building structure greenhouse area end is constructed using joists and girders configured to support said airtight sealed chamber positioned between said roof panels and said ceiling panels and said exterior wall panels and said interior wall panels.

6. The atrium/hybrid multi-purpose greenhouse building according to claim 5, wherein said joists and girders configured to support said airtight sealed chamber positioned between said roof panels and said ceiling panels and said exterior wall panels and said interior wall panels, further include:
(a) a roll formed galvanized steel segmented unistrut type open web joist horizontal member:
(b) said roll formed galvanized steel segmented unistrut type open web joist member having optional top or bottom roll formed channels throughout its full length for additional sideway control over top chord; and
(c) said roll formed galvanized steel segmented unistrut type open web joist member including elevated roll formed channel at the top or bottom to allow for roof or ceiling panel movement due to contraction or expansion.
wherein said joists and girders are configured to support transparent reinforced roof, wall and ceiling panels.

7. The atrium/hybrid multi-purpose greenhouse building according to claim 1, wherein said transparent roof panels, transparent wall panels and transparent ceiling panels further include:
(a) a first layer of transparent casting or moldable liquid polymer/glass material;
(b) a second layer of transparent casting or moldable liquid polymer/glass material; and
(c) a layer constructed of a continuous perforated sheet metal panel or mesh or synthetic fiber panel positioned sandwiched in between or located under said first and said second layer.

8. The atrium/hybrid multi-purpose greenhouse building according to claim 1, wherein said airtight sealed chamber positioned between said roof panels and said ceiling panels and said exterior wall panels and said interior wall panels, further includes capability to regulate the amount of light which reaches the interior space of the greenhouse area end of the building by enabling chemical fogging injection and degassing, and mechanical louvers opening and closing, and electrochemical alterations in the transparent panels used in construction.

9. The atrium/hybrid multi-purpose greenhouse building according to claim 1, wherein said roof located at said greenhouse area end includes a variable pitched roof, constructed to be pitched in accordance with climate conditions and environment where the atrium/hybrid multi-purpose greenhouse building structure is located.

10. The atrium/hybrid multi-purpose greenhouse building according to claim 1, wherein said roof located at said greenhouse area end includes a domed roof.

11. A method for making an atrium/hybrid multi-purpose greenhouse building, comprising the steps of:
(a) providing a base building structure having a multi-purpose area at one end and a greenhouse area at the opposite end;
(b) providing said base building structure having roof panels, ceiling panels, interior walls and exterior walls, and further including a roof located at the greenhouse area end;
(c) providing said roof and ceiling panels located at the greenhouse area end including roof and ceiling panels constructed of transparent polymer/transparent glass materials;
(d) providing said exterior walls of said greenhouse area end having a lower portion and an upper portion including exterior walls constructed of a solid non-transparent lower portion and a transparent upper portion;
(e) wherein said roof located at said greenhouse area end and said roof panels, ceiling panels and exterior wall panels are configured to include an airtight sealed chamber positioned between said roof panels and said ceiling panels and said exterior wall panels and said interior wall panels; and
further wherein said base building structure houses numerous compartmentalized multi-use areas, growing areas, secured hallways, decontamination rooms within said greenhouse area end and an office area within said multi-purpose area end.

12. The method for making an atrium/hybrid multi-purpose greenhouse building according to claim 11, wherein said airtight sealed chamber positioned between said roof panels and said ceiling panels and said exterior wall panels and said interior wall panels includes a continuous sealed air cavity which extends from floor level at all of said exterior walls up and throughout the entire roof area with said air cavity positioned between said roof panels and said ceiling panels.

13. The method for making an atrium/hybrid multi-purpose greenhouse building according to claim 12, wherein said sealed air cavity provides dead air space for insulation value as well as provides chambers for return or intake air circulated to and from the compartmentalized rooms within said greenhouse area end of the building.

14. The method for making an atrium/hybrid multi-purpose greenhouse building according to claim 13, wherein said return, or intake air circulated to and from the compartmentalized rooms within said greenhouse area end of the building is circulated through oil bath, fans and filters used to control infiltration of detrimental air borne particles and odor control within said greenhouse area end of the building.

15. The method for making an atrium/hybrid multi-purpose greenhouse building according to claim 11, wherein said base building structure greenhouse area end is constructed using joists and girders configured to support said airtight sealed chamber positioned between said roof panels and said ceiling panels and said exterior wall panels and said interior wall panels.

16. The method for making an atrium/hybrid multi-purpose greenhouse building according to claim 15, wherein said joists and girders configured to support said airtight sealed chamber positioned between said roof panels and said ceiling panels and said exterior wall panels and said interior wall panels, further include:
(a) a roll formed galvanized steel segmented unistrut type open web joist horizontal member;
(b) said roll formed galvanized steel segmented unistrut type open web joist member having optional top or bottom roll formed channels throughout its full length for additional sideway control over top chord; and
(c) said roll formed galvanized steel segmented unistrut type open web joist member including elevated roll formed channel at the top or bottom to al low for roof or ceiling panel movement due to contraction or expansion.
wherein said joists and girders are configured to support transparent reinforced roof, wall and ceiling panels.

17. The method for making an atrium/hybrid multi-purpose greenhouse building according to claim 11, wherein said transparent roof panels, transparent wall panels and transparent ceiling panels further include:
(a) a first layer of transparent casting or moldable liquid polymer/glass material;
(b) a second layer of transparent casting or moldable liquid polymer/glass material; and
(c) a layer constructed of a continuous perforated sheet metal panel or mesh or synthetic fiber panel positioned sandwiched in between or located under said first and said second layer.

18. The method for making an atrium/hybrid multi-purpose greenhouse building according to claim 11, wherein said airtight sealed chamber positioned between said roof panels and said ceiling panels and said exterior wall panels and said interior wall panels, further includes capability to regulate the amount of light which reaches the interior space of the greenhouse area end of the building by enabling chemical fogging injection and degassing, and mechanical louvers opening and closing, and electrochemical alterations in the transparent panels used in construction.

19. The method for making an atrium/hybrid multi-purpose greenhouse building according to claim 11, wherein said roof located at said greenhouse area end includes a variable pitched roof, constructed to be pitched in accordance with climate conditions and environment where the atrium/hybrid multi-purpose greenhouse building structure is located.

20. The method for making an atrium/hybrid multi-purpose greenhouse building according to claim 11, wherein said roof located at said greenhouse area end includes a domed roof.
